(19) United States
(12) Patent Application Publication
(10) Pub. No.: US 2007/0120778 A1
(43) Pub. Date: May 31, 2007

(54) Method and apparatus for driving a display panel

(75) Inventors: Naoya Kimura, Chiba (JP); Tetsurou Hara, Hiogo (JP); Takayuki Shimizu, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Tokyo (JP)

(21) Appl. No.: 11/546,565

(22) Filed: Oct. 12, 2006

(30) Foreign Application Priority Data
Oct. 17, 2005 (JP) 2005-302093
Jul. 27, 2006 (JP) 2006-204184

(51) Int. Cl. G09G 3/30

(52) U.S. Cl. 345/76

(57) ABSTRACT

A drive apparatus of a display panel is provided with an anode driver that drives m anode lines CL, a cathode driver that scans n cathode lines RL, and control means. In a process of pre-charging a parasitic capacity Cp of display elements connected to any of the scan lines RL whichever selected by the cathode driver, the control means switches a connection of L of the n scan lines RL and the m anode lines CL to a ground terminal, and applies voltage control with (L/n)×Vccr for application of an initial output voltage of the anode driver at about an EL element drive voltage Vf. In this manner, the parasitic capacity Cp of the EL elements connected to L scan lines RL is pre-charged. With such a drive apparatus of the display panel, without causing to be complicated in configuration, and without increasing the size of the circuit, it becomes possible to set and control a voltage for pre-charging a parasitic capacity of organic EL elements to be any needed voltage or current.

### BACKGROUND OF THE INVENTION

1. Technical Field

The present invention relates to a driving method and a driving apparatus of a display panel using a light-emitting element such as an organic electroluminescence element (hereinafter, referred to as “organic EL element”) being a self-light-emitting element.

2. Description of the Related Art

The previously-known technology about a method or apparatus of driving a display panel using a light-emitting element, e.g., organic EL element, is found in documents, including:

Patent Document 1; Japanese Patent Kokai No. 2002-202754,

Patent Document 2; Japanese Patent Kokai No. 2002-244612,

Patent Document 3; Japanese Patent Kokai No. 2004-302025,

Patent Document 4; Japanese Patent Kokai No. 2005-37498, and

Patent Document 5; Japanese Patent Kokai No. 2005-156859.

Patent Document 1 describes the technology about an organic EL drive circuit and a passive matrix organic EL display device. In the passive matrix organic EL display device, the organic EL drive circuit is capable of reducing a charging current that occurs at the time of scan line switching to organic EL elements of any not-selected scan line.

Patent Document 2 describes the technology for a device that drives capacitive light-emitting elements, e.g., organic EL elements. The drive apparatus suppresses the peak of a current to be charged to the parasitic capacity of the capacitive light-emitting elements so that the light-emitting elements or others are protected from any damage possibly caused by the peak current.

Patent Document 3 describes the technology for a method of driving a light-emitting display panel of a passive drive type. When time ratio grayscale is put into effect for the light-emitting display panel using light-emitting elements, e.g., organic EL elements, this drive method can implement satisfactory gray scale display without dividing that much the brightness resolution.

Patent Document 4 describes the technology for a device that drives a light-emitting display panel using light-emitting elements, e.g., organic EL elements. The drive apparatus enables to reduce horizontal crosstalk that occurs depending on the light-on state of the light-emitting elements, i.e., light-on ratio of elements calculated for every scan line, and a dimmer setting value.

Patent Document 5 describes the technology for a device that drives a self-light-emitting display panel, which is capable of gray scale display with accuracy. In the display panel of a passive drive type in which self-light-emitting elements, e.g., organic EL elements, are arranged in a matrix, the size increase is prevented for a circuit, the self-light-emitting elements are pre-charged with good efficiency, and a time is previously allocated for the self-light-emitting elements to emit light.

FIG. 2 is a schematic circuit diagram showing an exemplary configuration of a previous display panel drive apparatus of a passive drive type described in Patent Document 5 or others.

A passive drive display panel 10 includes a plurality of anode lines CL (=CL0, CL1, CL2, . . . , and CLm) and a plurality of cathode lines RL (=RL0, RL1, RL2, . . . , and RLn), which are arranged in a matrix. At their intersections, a self-light-emitting element, e.g., an organic EL element (hereinafter, referred to simply as “EL element”) 11 (=11-0, 11-0, and others) is each connected. The EL element 11 is a light-emitting element of a capacitive type that can be changed in configuration to that of an equivalent circuit, in which a light-emitting element E that is electrically a diode component is coupled in parallel to a parasitic capacity Cp.

In such a display panel 10, if assuming that the anode line CL is a data line and the cathode line RL is a scan line, a device of driving such lines is provided with an anode driver 20 and a cathode driver 30.

The anode driver 20 is provided with a plurality of constant-current power sources 21 (=21-0, 21-1, 21-2, . . . , and 21-m) and a plurality of drive switches 22 (=22-0, 22-1, 22-2, . . . , and 22-n). The constant-current power sources 21 are each a drive source operating in response to application of a power supply voltage V1, and the drive switches 22 are for selecting the anode lines CL. The drive switches 22 each switch a connection between the anode lines CL and the constant-current power sources 21 or a ground (hereinafter, referred to as “GND”) using a light-emitting control circuit that is not shown. The cathode driver 30 is provided with a plurality of scan switches 31 (=31-0, 31-1, 31-2, . . . , and 31-n) for scanning of the cathode lines RL in a sequential manner. The scan switches 31 each switch a connection between the cathode lines RL and an inverse bias voltage V2 or a GND using a light-emitting control circuit that is not shown.

In such a drive apparatus, a light-emitting control circuit (not shown) sequentially selects the cathode lines RL at regular time intervals for scanning. In synchronization with scanning as such, the anode lines CL are driven by a constant current coming from the constant-current power sources 21 so that the EL elements 11 at any arbitrary intersections are made to emit light.

Assumed here is a case of making the EL element 11-00 emit light at an intersection of the anode line CL0 and the cathode line RL0. In this case, the scan switch 31-0 is switched to the GND side, and the cathode line RL0 is scanned. On the other hand, the anode line CL0 is connected with the constant-current power source 21-0 by the drive switch 22-0. To the remaining cathode lines RL1, RL2, and others, the inverse bias voltage V2 is applied by the scan switches 31-1, 31-2, and others, and the remaining anode lines CL1, CL2, and others are connected to the GND side by the drive switches 22-1, 22-2, and others. As a result, only the EL element 11-00 is biased in the forward direction, and emits light. The remaining EL elements 11 do not emit light because no constant current comes from the constant-current power sources 21-1, 21-2, and others.

When a light-emitting control voltage (drive voltage) is applied to the EL elements 11, an electric charge corresponding to the electric capacity of the EL elements 11 flows into an electrode and then is accumulated as a displacement current. When a fixed level of voltage unique to the EL elements 11 is exceeded, i.e., light-emission threshold current, a current starts flowing from the electrode, i.e., on the anode side of the light-emitting element E, to an organic layer configuring a light-emitting layer. The EL elements 11 then emit light with the intensity (brightness) substantially proportional to the current, i.e., drive current. When the drive voltage is equal to or lower than the light-emitting threshold voltage, the EL elements 11 hardly receives a current, and thus do not emit light. The brightness characteristics tend to show the higher light-emission brightness as the drive voltage is increased in value for application to a light-emittable area whose voltage is higher than the light-emitting threshold voltage.

The passive drive display panel 10 including such EL elements 11 adopts time ratio grayscale control as a scheme for gray scale display. Under the time ratio grayscale control, the EL elements 11 are driven by a constant current to make those emit light, and their light-emitting time is regulated at fixed time intervals. With such time ratio grayscale control, however, the following problems are caused due to the capacitivity of the EL elements 11.

With passive driving, first of all, an electric charge is accumulated in the parasitic capacity Cp of the EL element 11 as a displacement current, and then the EL element 11 starts emitting light. Therefore, If the parasitic capacity Cp of the EL element 11 is not charged (this is referred to pre-charging), it resultantly lengthens the time for the element voltage of the EL element 11 to increase up to the light-emitting threshold value. If this is the case, the EL element 11 does not emit light to a sufficient level. In consideration thereof, with time ratio grayscale control, there needs to adopt cathode reset or others as a scheme to provide the EL elements 11 with a constant voltage or a constant current immediately before the EL elements 11 start emitting light, and pre-charge the parasitic capacity Cp of the EL elements 11.

FIGS. 3A to 3D are each a diagram showing the operation of cathode reset in the conventional drive apparatus of FIG. 2 described in Patent Document 4 and others. FIG. 3A shows the light-on state, FIG. 3B shows the reset state, FIG. 3C shows the pre-charge state, and FIG. 3D shows the light-on state. FIG. 4 is a schematic timing diagram for cathode reset of FIGS. 3A to 3D. In the timing diagram of FIG. 4, a reference character t0 denotes the reset starting time of FIG. 3B, and a reference character t1 denotes the time range covering the pre-charge starting and ending times of FIG. 3C, which is completed in a short time after the reset of FIG. 3B is done.

Described next is the cathode operation in the display panel 10 of FIG. 2 from the state of FIG. 3A to the state of FIG. 3D in the next scanning operation. In the state of FIG. 3A, the EL element 11-00 connected to the anode line CL0 and the cathode line RL0 is driven for light emission, for example. In the state of FIG. 3D, the EL element 11-01 connected to the anode CL0 and the cathode RL1 is driven for light emission, for example.

In the light-on state of FIG. 3A, when the EL element 11-00 is driven for light emission, the drive switch 22-0 of the anode driver 20 is changed in level to high (hereinafter, referred to as “H”) on the side of the constant-current power source 21-0. The scan switch 31-0 of the cathode driver 30 is changed in level to low (hereinafter, referred to as “L”) on the GND side so that the cathode line RL0 is scanned. The remaining scan switches 31-1 to 31-n are changed in level to “H” on the side of the inverse bias voltage V2 to put the cathode lines RL1 to RLn into the no-scan state. The drive current flows in the path from the constant-current power source 21-0 to, in this order, the drive switch 22-0, the anode line CL0, the EL element 11-00, the cathode line RL0, the scan switch 31-0, and the GND. With such a flow of the drive current, the EL element 11-00 emits light, and the parasitic capacity Cp thereof is charged.

In the reset state of FIG. 3B (time t0 of FIG. 4), all of the drive switches 22-0 to 22-m (=all anode lines CL0 to CLm), and all of the scan switches 31-0 to 31-n (=cathode lines RL0 to RLn) are changed in level to “L” on the GND side. Herein, the drive switches 22-0 to 22-m may be changed to the GND side before the time t0. In response to such level change, the electric charge accumulated in the parasitic capacity Cp of each of the EL elements 11-00 to 11-0n is discharged in the path from the cathode lines RL0 to RLn to, in this order, the scan switches 31-0 to 31-n, and the GND. The electric charge accumulated in the wiring capacity of the anode line CL0 or others is discharged in the path from the drive switch 22-0 to the GND, and this is the end of the reset operation (before the time t1 of FIG. 4).

In the pre-charge state of FIG. 3C (about immediately before the time t1 of FIG. 4), for making the EL element 11-01 emit light through scanning of the next cathode line RL1, all of the drive switches 22-0 to 22-m (=all anode lines CL0 to CLm) are changed in level all at once to “H” on the side of the constant-current power sources 21-0 to 21-m. Also, with the scan switch 31-1 (=the cathode line RL1) remained in the level of “L” on the GND side, the remaining scan switches 31-0, and 31-2 to 31-n (=cathode lines RL0, and RL1 to RLn) are changed in level to “H” on the side of the inverse bias voltage V2.

In response, in a short time, the drive current flows in the path from the constant-current power source 21-0 to, in this order, the drive switch 22-0, the anode line CL0, the parasitic capacity Cp of the EL element 11-01, the cathode line RL1, the scan switch 31-1, and the GND. Also, the electric charge accumulated in the parasitic capacity Cp of each of the remaining EL elements 11-00, and 11-02 to 11-n is discharged in the path from the anode line CL0 to, in this order, the parasitic capacity Cp of the EL element 11-01, the cathode line RL1, the scan switch 31-1, and the GND. As such, the parasitic capacity CP of the next EL element 11-01 is rapidly pre-charged for light emission (about the time t1 of FIG. 4).

Thereafter, in the light-on state of FIG. 3D, in response to the drive current for supply from the constant-current power source 21-0 to the anode line CL0, the forward-direction voltage of the EL element 11-01 is momentarily increased, and the EL element 11-01 accordingly emits light.

### SUMMARY OF THE INVENTION

The issue here is that the previous cathode reset has the following problems.

FIG. 5 is a schematic timing diagram for use to describe a problem of rapid increase observed in outputs of the cathode lines of FIG. 2. FIG. 5 is a diagram corresponding to the times t0 and t1 of FIG. 4.

With the previous cathode reset, at about the time t1 after the time t0, the cathode lines RL0, and RL2 to RLn except the to-be-scanned cathode line RL1 are changed in level all at once to “H”. Utilizing such simultaneous level change, any excessive electric charge of the parasitic capacities Cp of the remaining cathode lines RL0, and RL2 to RLn is directed to the parasitic capacity Cp of the to-be-scanned cathode line RL1 in addition to the constant current drive voltage. In this manner, the parasitic capacity Cp of the cathode line RL1 is rapidly pre-charged.

Such previous cathode reset, however, has a problem of not being able to control influences of the parasitic capacity and the parasitic resistance of the display panel 10. Therefore, in a case where the power supply voltage V1 of the anode driver 20 and the inverse bias voltage V2 of the cathode driver 30 share the same value, at about the time t1, the output voltage on the side of the anode lines CL generally tends to jump up. The anode lines CL are thus applied with a voltage that is unexpectedly high in level, thereby causing a problem of damaging the EL elements 11, resulting in not satisfactory display, and others. There is another problem of causing artificial luminescence, e.g., black display slightly glows. This is due to the voltage increase of the anode lines CL that are not supposed to be changed in level to “H”, and thus a current momentarily flows to the anode lines CL that are not supposed to be driven.

For solving such problems, there has been proposed another method of controlling, separately from the power supply voltage V1 of the anode driver 20, the inverse bias voltage V2 of the cathode driver 30 not to exceed the threshold voltage Vth for driving. This method, however, requires generating two different voltages, i.e., the power supply voltage V1 and the inverse bias voltage V2. This thus complicates the circuit configuration to a further extent, and the resulting circuit occupies the drive apparatus.

As such, none of the methods described above is satisfactory, i.e., not able to control the setting of the pre-charge voltage of the parasitic capacity Cp of the EL element 11 to any needed voltage or current, or even if such control is possible, the drive apparatus gets complicated in configuration, and the circuit is increased in size.

A first invention of the present invention is directed to a drive method or a drive apparatus, for a display panel in which a display element is connected to every intersection point of a plurality of data lines and a plurality of scan lines, of turning on the display elements with a flow of a drive current from the data lines to the scan lines via the display elements. In the display method or apparatus, in a pre-charging process a parasitic capacity of the display elements connected to any of the scan lines whichever selected, a parasitic capacity of the display elements connected to any of the scan lines not selected but predetermined is pre-charged. In a process of turning on the display elements connected to the selected scan line, the display elements connected to the selected scan line are driven to light.

A second invention is directed to a drive method or a drive apparatus for a display panel in which a display element is connected to every intersection point of m (where m is a positive integer of 2 or larger) data lines and n (where n is a positive integer of 2 or larger) scan lines, of turning on the display elements by applying an output voltage of a data line drive circuit to the data lines, by switching a connection of the scan lines in a scan line drive circuit from a voltage terminal of receiving a drive voltage Vccr to a ground terminal of receiving a ground voltage, and by flowing a drive current from the data lines to the scan lines via the display elements. In the drive method or apparatus, in a process of pre-charging a parasitic capacity of the display elements connected to any of the scan lines whichever selected, a parasitic capacity of the display elements connected to L (where L is a positive integer) of the n scan lines is pre-charged by switching a connection of the L scan lines and the m data lines to the ground terminal, and by applying voltage control with (L/n)×Vccr for application of an initial output voltage of the data line drive circuit at about a display element drive voltage Vf.

A third invention is directed to a drive method or a drive apparatus, for a display panel in which a display element is connected to every intersection point of a plurality of data lines and a plurality of scan lines, of turning on the display elements by applying an output voltage of a data line drive circuit to the data lines, by changing a potential level of the scan lines from high to low in a scan line drive circuit, and by flowing a drive current from the data lines to the scan lines via the display elements. In the drive method or apparatus, in a process of pre-charging a parasitic capacity of the display elements connected to any of the scan lines whichever selected, when every data of the data lines is detected as being zero, only the selected scan line is changed in potential level to low when the data line drive circuit starts making an output, and a parasitic capacity of the display elements connected to the selected scan line is pre-charged.

A fourth invention is directed to a drive method or a drive apparatus, for a display panel in which a display element is connected to every intersection point of m data lines and n scan lines, of turning on the display elements by applying an output voltage of a data line drive circuit to the data lines, by switching a connection of the scan lines in a scan line drive circuit from a voltage terminal of receiving a drive voltage Vccr to a ground terminal of receiving a ground voltage, and by flowing a drive current from the data lines to the scan lines via the display elements. In the drive method or apparatus, in a process of pre-charging a parasitic capacity of the display elements connected to any of the scan lines whichever selected, a parasitic capacity of the display elements connected to L of the n scan lines is pre-charged by determining the value of L for the n scan lines using a light-on ratio of the display elements calculated for each of the scan lines, by switching a connection of the L scan lines and the m data lines to the ground terminal, and by controlling an initial output voltage of the data line drive circuit with (L/n)×Vccr.

A fifth invention is directed to a drive method or a drive apparatus for a display panel in which a display element is connected to every intersection point of a plurality of data lines and a plurality of scan lines. In the drive method or apparatus, for turning on the display elements connected to any of the scan lines whichever selected and the data lines, the selected scan line is switched in connection from a voltage terminal of receiving a drive voltage to a ground terminal of receiving a ground voltage, and a drive current is supplied to the data lines to light the display elements. For turning off the display elements lit, the selected scan line is switched in connection from the ground terminal to the voltage terminal to put the scan line in a no-selected state, and a potential level of the data lines is changed to low to turn off the display elements. When the display elements are turned off, a light-off ratio is calculated for the display elements connected to the selected scan line to see how much of the display elements are turned off, and based on the light-off ratio, a voltage of the low-potential level is changed to control an amount of voltage change observed in the lit display elements when the display panel is turned off.

According to the first to fourth inventions, voltage control becomes applicable to an output of the data line drive circuit without causing the drive apparatus to get complicated in configuration, and without increasing the circuit size. This accordingly prevents a problem of damaging the display elements, resulting in not satisfactory display, and others, and enables pre-charging of the parasitic capacity.

According to the fifth invention, reduction of crosstalk can be achieved, which occurs depending on an amount of voltage change observed in any lit elements when the display panel is turned off.

The drive apparatus of the display panel is configured to include the data line drive circuit, the scan line drive circuit, and the control means.

When the display elements are lit, the data line drive circuit flows, for a display panel in which a display element is connected to every intersection point of m (where m is a positive integer of 2 or larger) data lines and n (where n is a positive integer of 2 or larger) scan lines, a drive current to the display elements through application of an output voltage to the data lines. When the display elements are not lit, the data line drive circuit switches a connection of the data lines to a low-potential terminal. The scan line drive circuit switches a connection of, at the time of selection of the scan lines, the scan lines from a voltage terminal of receiving a drive voltage Vccr to a ground terminal of receiving a ground voltage, and not at the time of selection of the scan lines, switches a connection of the scan lines to the ground terminal.

The control means pre-charges, in a process of pre-charging a parasitic capacity of the display elements connected to any of the scan lines whichever selected, a parasitic capacity of the display elements connected to L (where L is a positive integer) of the n scan lines by switching a connection of the L scan lines and the m data lines to the ground terminal, and by applying voltage control with (L/n)×Vccr for application of an initial output voltage of the data line drive circuit at about a display element drive voltage Vf.

### DETAILED DESCRIPTION OF THE INVENTION

### First Embodiment

Configuration in First Embodiment

FIG. 1 is a schematic diagram showing the configuration of a drive apparatus of a passive drive display panel in a first embodiment of the invention.

Similarly to the previous one, a passive drive display panel 40 includes a plurality of anode lines CL (=CL0, CL1, CL2, . . . , CLm−1, and CLm) and a plurality of cathode lines RL (=RL0, RL1, RL2, . . . , RLn−1, and RLn), which are arranged in a matrix. At their intersections, an EL element 41 (=41-0, 41-0, and others) is each connected. The EL elements 41 are each a self-light-emitting element. The EL elements 41 are each coupled with, in parallel, a parasitic capacity Cp.

In such a display panel 40, if assuming that the anode line CL is a data line and the cathode line RL is a scan line, a device of driving such lines is provided with an anode driver 50 being a data line drive circuit, and a cathode driver 60 being a scan line drive circuit.

The anode driver 50 is provided with a constant-current circuit 51, and a plurality of drive switches 53 (=53-0, 53-1, 53-2, . . . , 53-m−1, 53-m). The constant-current circuit 51 is a drive source that operates in response to application of a power supply voltage Vccc, and the drive switches 53 are for selecting the anode lines CL. The constant-current circuit 51 is configured by a plurality of constant-current power sources 52 (=52-0, 52-1, 52-2, . . . , 52-m−1, and 52-m). The drive switches 53 are each a switching element, switching a connection between the anode lines CL and the constant-current power sources 52 or a GND of a ground voltage Vssh using a timing control circuit 70, an anode data transfer circuit 81, and an anode driver control circuit 83.

The cathode driver 60 is provided with a plurality of scan switches 61 (=61-0, 61-1, 61-2, . . . , 61-n−1, and 61-n) for scanning of the cathode lines RL in a sequential manner. The scan switches 61 are each a switching element, switching a connection between the cathode lines RL and an inverse bias voltage Vccr or the GND of the ground voltage Vssh using the timing control circuit 70, a cathode data transfer circuit 82, and a cathode driver control circuit 84.

Note that, in FIG. 1, for convenient reference, the block diagrams of the anode driver 50, the constant-current circuit 51, and the cathode driver 60 are shown on the left side, and the circuit diagram for these block diagrams is shown on the right side.

The timing control circuit 70 exchanges a control signal or others with a control circuit, e.g., Central Processing Unit (CPU), via a CPU interface 69. The timing control circuit 70 takes charge of making an output of a cathode control signal S70 from internally-provided control means, making an output of timing signals varying in type, e.g., pre-charge timing, and time ratio grayscale timing, performing image processing, and the like. This timing control circuit 70 is connected with various components, i.e., the constant-current circuit 51 for application of timing control, the anode data transfer circuit 81, the cathode data transfer circuit 82, the anode driver control circuit 83, and the cathode driver control circuit 84.

The anode data transfer circuit 81 receives the cathode control signal S70, the anode data, and others from the timing control circuit 70. The anode data or others are entered into a latch circuit for transfer by a shift register or others. To the output side of the anode data transfer circuit 81, the anode driver control circuit 83 is connected. The cathode data transfer circuit 82 receives the cathode control signal S70, cathode line scan data, or others from the timing control circuit 70. The cathode line scan data or others are entered into the latch circuit for transfer by the shift register or others. To the output side of the cathode data transfer circuit 82, the cathode driver control circuit 84 is connected.

Together with the cathode control signal S70 coming from the timing control circuit 70, the anode driver control circuit 83 also receives the anode data or others coming from the anode data transfer circuit 81. The anode driver control circuit 83 exercises control over the anode driver 50, e.g., discharge, pre-charge, modulation timing, or others. Together with the cathode control signal S70 coming from the timing control circuit 70, the cathode driver control circuit 84 also receives the cathode line scan data or others coming from the cathode data transfer circuit 82. The cathode driver control circuit 84 exercises control over the cathode driver 60, e.g., discharge, pre-charge, sweep timing, non-sweep timing, or others.

A power supply voltage Vdd for driving use, and a ground voltage Vss are applied to the components, i.e., the timing control circuit 70, the anode data transfer circuit 81, the cathode data transfer circuit 82, the anode driver control circuit 83, and the cathode driver control circuit 84.

Drive Method for Display Panel of First Embodiment

FIGS. 6A to 6D are each a diagram showing the cathode operation for anode voltage control with cathode reset in the drive unit of FIG. 1. FIG. 6A shows the light-on state, FIG. 6B shows the reset state, FIG. 6C shows the pre-charge state, and FIG. 6D shows the light-on state. FIG. 7 is a schematic timing diagram for cathode reset of FIGS. 6A to 6D. In the timing diagram of FIG. 7, a reference character t0 denotes the reset starting time of FIG. 6B, and a reference character t1 denotes the time range covering the pre-charge starting and ending times of FIG. 6C, which is completed in a short time after the resetting of FIG. 6B is done.

Described next is the cathode operation in the display panel 40 of FIG. 1 from one state to another. e.g., from the state in which the EL element 41-00 connected to the anode line CL0 and the cathode line RL0 is driven for light emission to the state, in the next scanning operation, in which the EL element 41-01 connected to the anode line CL0 and the cathode RL1 is driven for light emission.

For driving the display panel 40, data and a control signal coming from the CPU (not shown) are forwarded to the timing control circuit 70 via the CPU interface 69. The timing control circuit 70 exercises timing control over the drive apparatus in its entirety, e.g., output of the cathode control signal S70, output of various timing signals including pre-charge timing and time ratio grayscale timing, and image processing.

As to the outputs from the timing control circuit 70, e.g., the anode data and the cathode data, the anode data or others are transferred to the anode driver control circuit 83 via the anode data transfer circuit 81. The anode driver control circuit 83 then switches a connection of the drive switches 53-0 to 53-m in the anode driver 50. The cathode data or others output from the timing control circuit 70 are transferred to the cathode driver control circuit 84 via the cathode data transfer circuit 82. The cathode driver control circuit 84 switches a connection of the scan switches 61-0 to 61-n in the cathode driver 60. The constant-current circuit 51 outputs a drive current of a fixed level from the constant-current power sources 52-0 to 52-m. The constant-current circuit 51 is under the timing control of the timing control circuit 70.

In the light-on state of FIG. 6A, when the EL element 41-00 is driven for light emission, the drive switch 53-0 (=anode line CL0) of the anode driver 50 is changed in level to “H” on the side of the constant-current power source 52-0. The scan switch 61-0 (=cathode line RL0) of the cathode driver 60 is changed in level to “L” on the GND side so that the cathode line RL0 is scanned. The remaining scan switches 61-1 to 61-n (=cathode lines RL1 to RLn) are changed in level to “H” on the side of the inverse bias voltage Vcc so that the cathode lines RL1 to RLn are put into the no-scan state. The drive current thus flows in the path from the constant-current power source 52-0 to, in this order, the drive switch 53-0, the anode line CL0, the EL element 41-00, the cathode line RL0, the scan switch 61-0, and the GND. With such a flow of the drive current, the EL element 41-00 emits light, and the parasitic capacity Cp thereof is charged.

In the reset state of FIG. 6B (time t0 of FIG. 7), all of the drive switches 53-0 to 53-m (=all anode lines CL0 to CLm) are changed in level to “L” on the GND side. Such level change is done under the control of the cathode control signal S70 coming from the timing control circuit 70. Out of the scan switches 61-0 to 61-n, only L (2≦L<n+1) pieces of the scan switches including the scan switch 61-1 (=cathode line RL1) are changed in level to “L” on the “GND” side. Through such L scan switches 61, the electric charge accumulated in the parasitic capacity Cp of each of the El elements 41 connected thereto is discharged to the GND side. The electric charge accumulated in the wiring capacity of the anode line CL0 or others is discharged in the path from the drive switch 53-0 to the GND, and this is the end of the reset operation (before the time t1 of FIG. 7). Herein, the drive switches 53-0 to 53-m may be entirely changed in level to the GND side before the time t0.

In the pre-charge state of FIG. 6C (about immediately before the time t1 of FIG. 7), for making the EL element 41-01 emit light through scanning of the next cathode line RL2, the drive switch 53-0 is changed in level to “H” on the side of the constant-current power source 52-0. Under the control of the cathode control signal S70 coming from the timing control circuit 70, out of the scan switches 61-0 to 61-n, only L (2≦L<n+1) pieces of the scan switches 61 (=cathode lines RL) including the scan switch 61-1 (=cathode line RL1) are remained in the level of “L” on the “GND” side. At the same time, the remaining (n+1−L) pieces of the scan switches 61 are changed in level to “H” on the side of the inverse bias voltage Vccr. In response, in a short time, the drive current flows in the path from the constant-current power source 53-0 to, in this order, the drive switch 53-0, the anode line CL0, the parasitic capacity CLp of the EL element 41-01, the cathode line RL1, the scan switch 61-1, and the GND. Also, the electric charge accumulated in the parasitic capacity Cp of each of the remaining (L−1) pieces of the EL elements 41-00 and others is discharged in the path from the anode line CL0 to, in this order, the parasitic capacity Cp of the EL element 41-01, the cathode line RL1, the scan switch 61-1, and the GND. As such, the parasitic capacity CP of the next EL element 41-01 is rapidly charged for light emission (about the time t1 of FIG. 7).

Thereafter, in the light-on state of FIG. 6D, in response to the drive current for supply from the constant-current power source 52-0 to the anode line CL0, the forward-direction voltage of the EL element 41-01 is momentarily increased, and the EL element 41-01 accordingly emits light.

Effects of First Embodiment

FIGS. 8A and 8B are each a schematic diagram showing a waveform of the anode operation with the cathode reset of FIG. 1, for comparison use with the previous example.

In the first embodiment, at the time of resetting and pre-charging with cathode reset, the cathode control signal S70 coming from the control means inside of the timing control circuit 70 is used as a cue for level change to “L”. That is, all of the anode lines CL0 to CLm and L pieces of the cathode lines RL out of the cathode lines RL0 to RLn are changed in level all at once to “L”. Through such level change, the parasitic capacity Cp of the EL elements 41 is pre-charged in advance for next light emission. This thus enables to control the initial output voltage of the anode lines CL at the time when the anode driver 50 starts making an output to be, substantially, Vth {=[L/(n)]×Vccr} as shown in FIG. 8B. The output voltage Vth can be thus close in value to the anode drive voltage Vf, thereby preventing the outputs of the anode lines from jumping up in value as has been the case of FIG. 8A.

Accordingly, without causing a drive apparatus to get complicated in configuration, and without increasing the size of the circuit, it becomes possible to implement voltage application to the outputs of the anode lines at their set potential with the minimum resolution of (1/the number of cathode lines n). This favorably prevents any problem of damaging the EL elements 41, or resulting in not satisfactory display of time ratio grayscale, and the parasitic capacity Cp of the EL elements 41 can be pre-charged.

### Second Embodiment

Configuration in Second Embodiment

FIG. 9 is a schematic diagram showing the configuration of a drive apparatus of a passive drive display panel in a second embodiment of the invention. In FIG. 9, any component same as that of FIG. 1 in the first embodiment is under the same reference numeral.

In a drive apparatus of a passive drive display panel in the second embodiment, compared with the drive apparatus of the first embodiment, “0” detection means 70a, 81a, and 83a are additionally provided to the timing control circuit 70, the anode data transfer circuit 81, and the anode driver control circuit 83, respectively. These “0” detection means are provided to detect any case that the anode data entirely indicates. “0”, e.g., black. Their detection results of “0” are to be forwarded to the cathode data transfer circuit 82 or the cathode driver control circuit 84. The remaining configuration is the same as that of the first embodiment.

Drive Method for Display Panel of Second Embodiment

FIG. 10 is a schematic timing diagram showing the control operation with cathode reset when anode data of FIG. 9 indicates “0”. The timing diagram of FIG. 10 is corresponding to that of FIG. 7 in the first embodiment.

Exemplified now is a case with cathode reset, where every anode data indicates “0”, i.e., black, at the time t0 of reset starting, before the time t1 of reset ending, and about the time t1 of pre-charging. In such a case, the “0” detection means 70a, 81a, and 83a are all asserted (activated) in the timing control circuit 70, the anode data transfer circuit 81, and the anode driver control circuit 83, respectively. The timing control circuit 70, the cathode data transfer circuit 82, or the cathode driver control circuit 84 changes the level to “L” (scanning) of only the cathode line RL1 out of the cathode lines RL0 to RLn but not the remaining scan lines (cathode lines).

Effects of Second Embodiment

According to the second embodiment, providing the “0” detection means 70a, 81a, and 83a favorably enables control application, without performing cathode reset, when every anode data indicates black. As a result, any unnecessary parasitic capacity Cp can be prevented from being pre-charged, no artificial luminescence occurs, and the power consumption can be reduced.

### Third Embodiment

In the first embodiment, at the time of resetting and pre-charging with cathode reset, the parasitic capacity Cp of the EL elements 41 configuring the display panel 40 is pre-charged. The issue here is that the configuration of the first embodiment does not reduce crosstalk, which is caused depending on the light-on state of the EL elements 41, i.e., the light-on ratio of the EL elements 41 calculated for every to-be-scanned cathode line RL, and a dimmer value.

More specifically, in order to reduce the crosstalk caused depending on the light-on state of the EL elements 41, i.e., the light-on ratio of the EL elements 41 calculated for every to-be-scanned cathode line RL, and a dimmer value, there needs to control pre-charging of the parasitic capacity Cp of the EL elements 41 configuring the display panel 40. That is, when many of the EL elements 41 are not lit (low light-on ratio), a phenomenon is observed that rising of the to-be-scanned cathode lines RL gets slowly. When many of the EL elements 41 are lit (high light-on ratio), on the other hand, a phenomenon is observed that rising of the to-be-scanned cathode lines RL gets steep. With a low light-on ratio, the screen looks a little darker, and with a high light-on ratio, the screen looks a little brighter, i.e., horizontal crosstalk is occurring.

The technology of Patent Document 4 is trying to solve such a problem, however, the technology does not yet serve enough. In consideration thereof, the third embodiment of the invention is solving such a problem as below.

Configuration in Third Embodiment

FIG. 11 is a schematic diagram showing the configuration of a drive apparatus of a passive drive display panel in the third embodiment of the invention. In the drawing, any component same as that of FIG. 1 in the first embodiment is provided with the same reference numeral.

In a drive apparatus of a passive drive display panel in the third embodiment, the timing control circuit 70 of the first embodiment is configured by a register circuit 71, a semiconductor memory 72, a graphic random access memory (hereinafter, referred to as “GRAM”) control circuit 73, a cathode L line calculation circuit 74, and others. The semiconductor memory 72 is exemplified by a GRAM, and stores therein image data, for example. The GRAM control circuit 73 exercises control over the GRAM 72 in terms of access making.

The register circuit 71 is connected to the CPU interface 69, and keeps data of a lookup table. The parameters in the lookup table include various timings, e.g., pre-charge timing and time ratio grayscale timing, and the light-on ratios of the EL elements 41 calculated for every to-be-scanned cathode line RL. Such a register circuit 71 is connected with the GRAM control circuit 73, and the cathode L line calculation circuit 74. The cathode L line calculation circuit 74 calculates a value of L with (L/the number of cathode lines n)×cathode drive voltage Vf (where L; the number of cathode lines RL to be changed in level to “L” (scanning) at the time of resetting and pre-charging with cathode reset). Such calculation is made using the lookup table with parameters of light-on ratios of the EL elements 41 calculated for every to-be-scanned cathode line RL, and a circuit of calculating the light-on ratio from the “0” data detection of the anode data output. This calculation result is forwarded to the cathode data transfer circuit 82 or the cathode driver control circuit 84 as a control signal. The remaining configuration is similar to that of the first embodiment.

Drive Method for Display Panel of Third Embodiment

FIGS. 12A to 12C are each a diagram showing a waveform of the anode operation with the cathode reset of FIG. 11, for comparison use with FIG. 1;

In the third embodiment, in FIG. 7 showing the operation in the first embodiment, the cathode L line calculation circuit 74 is used to calculate a value of L for scanning L pieces of the cathode lines RL0 to RLn at the time of resetting and pre-charging with cathode reset. The calculation result is forwarded to the cathode data transfer circuit 82 or the cathode driver control circuit 84 as a control signal.

Herein, the cathode L line calculation circuit 74 calculates a value of L with (L/the number of cathode lines n)×cathode drive voltage Vf. Such calculation is made based on the data provided by the register circuit 71 via the CPU interface 69 at the time of execution of cathode reset, using the lookup table with parameters of light-on ratios of the EL elements 41 calculated for every to-be-scanned cathode line RL, and a circuit of calculating the light-on ratios from the “0” data detection of the anode data output.

Based on the calculation result or others, at the time of resetting and pre-charging with cathode reset, by the anode driver 50 under the control of the anode driver control circuit 83 and the cathode driver 60 under the control of the cathode driver control circuit 84, all of the anode lines CL0 to CLm, and the L cathode lines RL out of cathode lines RL0 to RLn are changed in level all at once to “L” so that the parasitic capacity Cp of the next EL element 41 is pre-charged for light emission.

As such, by changing in level to “L” the L cathode lines RL out of the cathode lines RL0 to RLn, as shown in FIG. 12C, the anode line output voltage when the anode driver 50 starts making an output can be controlled in consideration of the light-on ratio, i.e., the voltage when the EL elements are started to be driven can be controlled to the voltage of (L/n)×Vccr. As such, the control voltage can be set to a value close to the anode drive voltage Vf.

Effects of Third Embodiment

In the third embodiment, the cathode line calculation circuit 74 calculates a value of L for the cathode lines RL for scanning at the time of execution of cathode reset, and the parasitic capacity Cp of the EL elements 41 is pre-charged. As such, the anode line output voltage when the anode driver 50 starts making an output can be controlled in consideration of the light-on ratio, i.e., i.e., the voltage when the EL elements are started to be driven can be controlled to the voltage of (L/n)×Vccr. Therefore, by enabling to set the control voltage to a value close to the anode drive voltage Vf, without causing a drive apparatus to get complicated in configuration, and without increasing the size of the circuit, it becomes possible to implement voltage application to the outputs of the anode lines at their set potential with the minimum resolution of (1/the number of cathode lines n).

Accordingly, reduction of crosstalk observed in the first embodiment (FIG. 1) can be achieved, which occurs depending on the damage state of such EL elements 41 as shown in FIGS. 12A and 12B, and on the light-on state of the EL elements 41, i.e., light-on ratio of elements calculated for every scan line, and a dimmer setting value. Moreover, the parasitic capacity Cp of the EL element 41 can be pre-charged.

### Fourth Embodiment

In the drive apparatus of the passive drive display panel in the first to third embodiments, when the gray scale display is made by time ratio grayscale control, for example, a switching signal is provided by the anode driver 50 so that the drive switches 53-0 to 53-m are turned on or off. The switching signal is controlled in pulse width under PWM (Pulse Width Modulation).

The issue here is that with the drive method with PWM, the artificial luminescence (crosstalk) occurs, thereby possibly deteriorating the image quality. With the artificial luminescence, a gray display glows and looks like light gray. This is caused depending on the light-off state of the EL elements 41, i.e., a dimmer value of the EL elements 41 for every to-be-scanned cathode line RL, timing of turning off the EL elements 41, and a light-off ratio thereof at the timing. For improvement, in the fourth embodiment, an amount of voltage change observed in the voltage of the lit display elements when the display panel 40 is turned off is made controllable so that crosstalk reduction is achieved.

Configuration in Fourth Embodiment

FIG. 13 is a schematic diagram showing the configuration of a drive apparatus of a passive drive display panel in the fourth embodiment of the invention. Any component same as that of FIG. 1 in the first embodiment is provided with the same reference numeral.

Similarly to the first embodiment, the passive drive display panel 40 in the fourth embodiment includes a plurality of anode lines CL (=CL0, CL1, CL2, . . . , CLm−1, and CLm) and a plurality of cathode lines RL (=RL0, RL1, RL2, . . . , RLn−1, and RLn), which are arranged in a matrix. At their intersections, the EL element 41 (=41-00, 41-01, and others) is each connected. Each of the EL elements 41 is provided with the parasitic capacity Cp in parallel. Each of the anode lines CL includes a plurality of wiring resistances R42 connected in series, and each of the cathode lines RL includes a plurality of wiring resistance R43 connected in series.

In such a display panel 40 including the parasitic capacities Cp and the wiring resistances R42 and R43, if assuming that the anode line CL is a data line and the cathode line RL is a scan line, a device of driving such lines is provided with an anode driver 90 and the cathode driver 60. The anode driver 90 is different from that of the first embodiment, and the cathode driver 60 is the same as that in the first embodiment.

The anode driver 90 is provided with the constant-current circuit 51, a plurality of drive switches 53 (53-0, 53-1, 53-2, . . . , 53-m−1, and 53-m), and a plurality of drive switches 54 (=54-0, 54-1, 54-2, . . . , and 54-m). The constant-current circuit 51 is a drive source operating in response to application of a power supply voltage Vccc. The drive switches 53 are for selecting the anode lines CL, and the drive switches 54 are for selecting either a single resistance 91 or a set of parallel resistances 91 and 92. The constant-current circuit 51 is configured by a plurality of constant-current power sources 52 (=52-0, 52-1, 52-2, . . . , 52-m−1, and 52-m). The parallel resistances 91 and 92 are both connected to a power supply line 93. The power supply line 93 includes a plurality of wiring resistance R93, which are connected in series, and an end of the power supply line 93 is connected to the GND of the ground voltage Vssh via a Zener diode 94.

The drive switches 53 are each a switching element, switching a connection between the anode lines CL and the constant-current power sources 52 or low voltage nodes N54 by a timing control circuit 100, the anode data transfer circuit 81, and the anode driver control circuit 83. The low voltage nodes N54 are connected to the power supply line 93 via each corresponding resistance 91, and to the power supply line 93 via each corresponding drive switch 54 and resistance 92. The drive switches 54 are each a switching element to be turned on or off by the anode driver control circuit 83. When turned on, the drive switches 54 are connected to the power supply line 93 via the parallel resistances 91 and 92, and when turned off, the drive switches 54 are connected to the power supply line 93 via the low voltage nodes N54 and the resistances 91.

Similarly to the first embodiment, the cathode driver 60 is provided with a plurality of scan switches 61 (=61-0, 61-1, 61-2, . . . , 61-n−1, and 61-n) for scanning of the cathode lines RL in a sequential manner. The scan switches 61 are each a switching element, switching a connection between the cathode lines RL and an inverse bias voltage Vccr or a GND of the ground voltage Vssh using the timing control circuit 100, the cathode data transfer circuit 82, and the cathode driver control circuit 84. The timing control circuit 100 is of different configuration from that of the first embodiment, and the cathode data transfer circuit 82 and the cathode driver control circuit 84 are both similar to those in the first embodiment.

The timing control circuit 100 exercises control over the drive apparatus in terms of timing, and includes a CPU control interface 101, a register circuit 102, a GRAM 103, a lookup table 104, and a timing generation circuit/GRAM control circuit 105. The CPU control interface 101 is connected to the CPU interface 69. The CPU interface 101 receives image display data, control command data, and others, from the CPU interface 69. The output side of the CPU control interface 101 is connected with the register circuit 102, the GRAM 103, and the lookup table 104.

The register circuit 102 is a circuit that keeps the control command data provided by the CPU control interface 101, and the output side thereof is connected with the timing generation circuit/GRAM control circuit 105, a light-off ratio calculation circuit 106, the constant-current circuit 51, the anode data transfer circuit 81, and the cathode data transfer circuit 82. The GRAM 103 is a memory that stores therein image display data provided by the CPU control interface 101, and the output side thereof is connected with the timing generation circuit/GRAM control circuit 105. The lookup table 104 is storage means that stores therein parameter data for use to determine, using the light-off ratio, the “L” (sync) drive performance of the anode lines CL, i.e., capability of changing the anode lines CL in level to “L”. The output side of the lookup table 104 is connected with the light-off ratio calculation circuit 106.

The timing generation circuit/GRAM control circuit 105 is configured by a timing generation circuit 105a, and a GRAM control circuit 105b. Herein, the timing generation circuit 105a generates a timing signal for image display, and the GRAM control circuit 105b exercises control over the GRAM 103 in terms of access making. The timing generation circuit/GRAM control circuit 105 outputs the image display data at any predetermined timing based on the control command data provided by the register circuit 102. The output side of the timing generation circuit/GRAM control circuit 105 is connected with the light-off ratio calculation circuit 106, the anode data transfer circuit 81, and the cathode data transfer circuit 82. Based on the control command data, the light-off ratio calculation circuit 106 calculates a light-off ratio by referring to the parameter data in the lookup table 104. The calculation result is forwarded to the anode data transfer circuit 81 and the anode driver control circuit 83, and the drive switches 54 are switched in connection to change the sync drive performance for a Zener voltage.

The anode data transfer circuit 81 transfers the image display data to the anode driver control circuit 83. The image display data is the one provided by the timing generation circuit/GRAM control circuit 105. Based on the image display data, the anode driver control circuit 83 is capable of switching a connection state of the driver switches 53 with the anode lines CL, the constant-current power sources 52, or the low voltage nodes N54. The cathode data transfer circuit 82 transfers the display data to the cathode driver control circuit 84. The display data is the one provided by the timing generation circuit/GRAM control circuit 105. Based on the display data, the cathode driver control circuit 84 is capable of switching a connection state of the scan switches 61 with the cathode lines RL, the power supply voltage Vccr, or the GND of the ground voltage Vssh.

FIG. 14 is a diagram showing exemplary parameter data to be kept in the lookup table 104 of FIG. 13.

The parameter data Rcon10, Rcon20, and others is data for use to determine the “L” (sync) drive performance for the anode lines CL using a light-off ratio (%).

Drive Method for Display Panel of Fourth Embodiment

FIGS. 15A and 15B, and FIGS. 15C and 15D are each a diagram showing the operation of causing crosstalk when anodes of FIG. 13 are turned off.

The passive drive display panel 40 is driven by the anode driver 90 and the cathode driver 60.

The image display data and the control command data coming from the CPU interface 69 are written to the GRAM 103 via the CPU control interface 101. The image display data read from the GRAM 103 is under the control of the timing generation circuit/GRAM control circuit 105 in terms of drive timing, and is forwarded to the anode driver 90 via the anode data transfer circuit 81, and the anode driver control circuit 83. The image display data is also forwarded to the cathode driver 60 via the cathode data transfer circuit 82, and the cathode driver control circuit 84.

If with PWM, the drive timing generated by the timing generation circuit/GRAM control circuit 105 is an analog signal, which indicates a pulse width corresponding to the brightness data proportional to the image display data. At the timing, for example, an input of image display data, a horizontal synchronizing signal and a vertical synchronizing signal are received, the input of image display data is subjected to PWM modulation in synchronous with the horizontal synchronizing signal, and a pulse having the length corresponding to the input of image display data is forwarded to the drive switches 53 (=53-0, 54-0, 53-1, 54-1, . . . , 53-m, and 54-m) of the anode driver 90. The cathodes in synchronous with the vertical synchronizing signal are sequentially subjected to “L” active scanning, and the scan line is driven one after another. As such, a signal for use to sequentially scanning the entire display panel is output to the scan switches 61 (=61-0, 61-1, 61-2, . . . , and 61-n) of the cathode driver 60.

As shown in FIG. 15A, in the passive drive display panel 40, when the cathode line RL, e.g., RL0, is in the level of “L”, the EL elements 41 (=41-00, 41-10, 41-20, and others) connected to the cathode line RL0 are lit. The degree of brightness of the EL elements 41 (=41-00, 41-10, 41-20, and others) is determined by the drive switches 53 and 54 (=53-0, 54-0, 53-1, 54-1, 53-2, 54-2, and others) of the anode driver 90.

As shown in FIGS. 15B to 15D, an input current to the EL elements 41 (=41-00, 41-10, 41-20, and others) corresponds to the input of image display data. When a specific anode line CL, e.g., CL1, is subjected to PWM modulation and the EL element 41-10 is turned off, the anode driver output is observed with reduction of a total amount of current flowing to the scan switch 61-0 of the cathode driver 60. In response thereto, the “L” drive voltage of the cathode driver 60 is lowered by the decreased amount of current by the wiring resistances R43 of the cathode line RL0, and the resistance components of the scan switch 61-0. Accordingly, the “H” drive voltage of the drive switches 53 (=53-0, 53-2, and others) of the anode driver 90 is determined by the threshold voltage Vf of each of the EL elements 41 in the display panel 40. Therefore, the voltage is reduced.

The “H” drive voltage of the anode driver 90 varies depending on the light-off ratio in the anode driver 90, the decreased amount of current, and the voltage reduction by the wiring resistances R42 of the anode lines CL relating to the anode drivers 90, the wiring resistances R43 of the cathode lines RL, the parasitic capacities Cp of the El elements 41, and others. Due to such a variation, the total amount of current flowing into the lit EL elements 41 (=41-00, 41-20, and others) shows some change, and the brightness proportional to the amount of current also shows some change before and after the timing when the remaining drive switches 53 and 54 (=53-1, 54-1, and others) are turned off. Therefore, such crosstalk as shown in FIGS. 16A and 16B occurs.

FIGS. 16A and 16B are each a schematic diagram showing the screen of the display panel 40 of FIG. 13. The left screens of FIGS. 16A and 16B both show image display data, and the right screens thereof both show the state of image display. In FIG. 16A, the upper left area (3) of the left screen is white data, and the upper right area (1) and the lower left area (2) are both gray data. In the state of image display of the right screen, the area (3) is displayed in white with no change, and the areas (1) and (2) are displayed in gray so that no crosstalk is occurring. On the other hand, in FIG. 16B, the upper left area (3) on the left screen is black data, and the upper right area (1) and the lower left area (2) are both gray data. In the state of image display of the right screen, the area (3) is displayed in black with no change, and the area (1) is displayed in gray. The area (2) is displayed in slightly light gray, and thus a crosstalk is occurring in the area (2).

In order to prevent such crosstalk from occurring, in the fourth embodiment, the parameter data of FIG. 14 is written to the lookup table 104 via the CPU control interface 101 for setting of a light-off ratio and the “L” (sync) drive performance. The lookup table 104 keeps parameter data for use to determine the “L” (sync) drive performance of the anode driver 90 for every light-off ratio of the display panel 40. After such parameter writing, the parameter data is forwarded to the light-off ratio calculation circuit 106.

The image display data written to the GRAM 103 is transferred to the components, i.e., the anode data transfer circuit 81, the cathode data transfer circuit 82, and the light-off ratio calculation circuit 106. Such data transfer is made by the timing generation circuit/GRAM control circuit 105. The light-off ratio calculation circuit 106 calculates the light-off ratio (%) for every tone from the transferred image display data. Using the light-off ratio (%) of the lookup table 104, i.e., 10, 20, and others, and data for use to set the “L” (synch” drove performance, e.g. Rcon10, Rcon20, and others, the “L” (sync) drive performance of the anode drive at every tone timing. Thus set value is then forwarded to the anode driver 90 for control application to on-resistance, e.g., resistance 91 or parallel resistances 91 and 92, of the drive switches 53 and 54 (=53-1, 54-1, and others), and to the “L” (sync) drive performance.

FIG. 17 is a schematic timing diagram showing the mechanism of causing the crosstalk of FIGS. 16A and 16B.

Through control application to the “L” (sync) drive performance of the anode driver 90, as shown in FIG. 17, the drive waveform of the to-be-turned-off anode line CL1 becomes controllably angled from “H” to “L”. With the resulting angle, by controlling any redundant electric charge of the area (3) of FIG. 16 caused by the light-off ratio, the total amount of current flowing into any lit EL elements 41 (=41-00, 41-20, and others) is set to a value of no change or a value of almost no change. The brightness proportional to the amount of current thus does not change any more before and after the timing when the remaining anode lines CL1 and others are turned off. Even if the brightness shows some change, the amount of change is suppressed to a level not perceivable for human eyes so that it seems like no crosstalk is occurring for human eyes.

Effects of Fourth Embodiment

According to the fourth embodiment, the drive apparatus of the display panel 40 is provided with the lookup table 104, the drive switches 53 and 54, and the light-off ratio calculation circuit 106. The lookup table 104 keeps parameter data, in which parameters include a light-off ratio indicating how much of the lit EL elements 41 are turned off. The drive switches 53 and 54 change the on-resistance values of the resistances 91 and 92 when the anode lines CL are turned off, and vary the sync drive performance. The light-off ratio calculation circuit 106 calculates a light-off ratio for every to-be-scanned cathode line RL at timings when the lit EL elements 41 are turned off. The light-off ratio calculation circuit 106 also exercises control over the drive switches 53 and 54 that change the on-resistance values of the resistances 91 and 92 using the parameter data. At the timings when the lit EL elements 41 are turned off for every to-be-scanned cathode line RL using the light-off ratio at the timings when the lit EL elements 41 are turned off for every to-be-scanned cathode line RL, the on-resistance values of the resistances 91 and 92 are controlled. Through such control, an amount of voltage change observed in the lit elements when the display panel 40 is turned off is controlled. In this manner, any crosstalk occurring depending on the amount of voltage change observed in the lit elements when the display panel 40 is turned off can be reduced.

Configuration in Fifth Embodiment

FIG. 18 is a schematic diagram showing the configuration of a drive apparatus of a passive drive display panel in a fifth embodiment of the invention. Any component same as that in FIG. 13 in the fourth embodiment is provided with the same reference numeral.

In a drive apparatus for a passive drive display panel in the fifth embodiment, as an alternative to the anode driver 90 of the fourth embodiment, a configuration-different anode driver 110 is provided. The anode driver 110 is provided with the constant-current circuit 51, a plurality of drive switches 53 (=53-0, 53-1, 53-2, . . . , 53-m−1, and 53-m), the resistance 91, the power supply line 93, and an “L” drive voltage setting circuit 120. The constant-current circuit 51 is a drive source, operating in response to application of the power supply voltage Vccc. The drive switches 53 are for selecting the anode lines CL (=CL0, CL1, CL1, CL2, . . . , and CLm). The resistance 91 is connected to, at one end, each of the low-voltage nodes N54, which are changed by the drive switches 53. The power supply line 93 is connected to the other end of the resistances 93, and includes a plurality of serially-connected wiring resistances R93. The “L” drive voltage setting circuit 120 varies the “L” drive voltage of the power supply line 93 based on the light-off ratio, and sets the voltage to any desired value.

The constant-current circuit 51 is configured by a plurality of constant-current power sources 52 (=52-0, 52-1, 52-2, . . . , 52-m−1, and 52-m). The drive switches 53 are each a switching element, switching a connection between the anode lines CL and the constant-current power sources 52 or the low-voltage nodes N54 using the anode driver control circuit 83.

The “L” drive voltage setting circuit 120 is configured to include a digital/analog converter (hereinafter, referred to as “DAC”) 121, and a voltage follower circuit 122. The remaining configuration is similar to that in the fourth embodiment. The DAC 121 converts the calculation result of the light-off ratio, i.e., a digital signal, coming from the light-off ratio calculation circuit 106 based on the control command data kept in the register circuit 102, and outputs the “L” drive voltage. The voltage follower circuit 122 is an operation amplifier, which receives the “L” drive voltage from the DAC 121, and makes the power supply line 93 retain the same voltage value as the “L” drive voltage.

FIG. 19 is a diagram showing exemplary parameter data to be kept in the lookup table 104 of FIG. 18.

The parameter data Vc110, Vc120, and others, is data for use to determine the “L” (sync) drive performance of the anode lines CL using the light-off ratio (%).

Drive Method for Display Panel in Fifth Embodiment

The operation of lighting and that of causing crosstalk are similar to those in the fourth embodiment, and only any different operation will be described below.

When the CPU control interface 101 receives the image display data and the control command data from the CPU interface 69, the data for setting the light-off ratio and the “L” drive voltage are written to the lookup table 104. The lookup table 104 keeps parameter data for use to determine the “L” drive voltage of the anode driver 110 for every light-off ratio of the display panel 40. Thus written data is then forwarded to the light-off ratio calculation circuit 106. The image display data provided to the CPU control interface 101 is written to the GRAM 103, and the written image display data is transferred to the components, i.e., the anode data transfer circuit 81, the cathode data transfer circuit 82, and the light-off ratio calculation circuit 106, by the timing generation circuit/GRAM control circuit 105.

The light-off ratio calculation circuit 106 calculates a light-off ratio for every tone using thus transferred image display data, and determines a setting value for the “L” drive voltage for the anode driver at every tone timing. Such a value determination is made based on the light-off ratios stored in the lookup table 104, and the data for use to set the “L” drive voltage. The setting value for the “L” drive voltage is an analog signal, and is first converted into a digital signal by the DAC 121 in the “L” drive voltage setting circuit 120. Thereafter, the voltage follower circuit 122 exercises control over the power supply line 93 to keep the value of the “L” drive voltage.

Through such control exercised over the “L” drive voltage, almost similarly to the fourth embodiment, the drive waveform of the to-be-turned-off anode line CL1 becomes controllably angled from “H” to “L”. With the resulting angle, by controlling any redundant electric charge caused by the light-off ratio, the total amount of current flowing into any lit EL elements 41 is set to a value of no change or a value of almost no change. The brightness proportional to the amount of current thus does not change any more before and after the timing when the remaining anode lines CL and others are turned off. Even if the brightness shows some change, the amount of change is suppressed to a level not perceivable for human eyes so that it seems like no crosstalk is occurring for human eyes.

Effects of Fifth Embodiment

According to the Fifth embodiment, the drive apparatus of the display panel 40 is provided with the lookup table 104, the “L” drive voltage setting circuit 120, and the light-off ratio calculation circuit 106. The lookup table 104 keeps parameter data, in which parameters include a light-off ratio indicating how much of the lit EL elements 41 are turned off. The “L” drive voltage setting circuit 120 sets the “L” drive voltage of the power supply line 93 for turning off the anode lines CL. The light-off ratio calculation circuit 106 calculates a light-off ratio for every to-be-scanned cathode line RL at timings when the lit EL elements 41 are turned off. The light-off ratio calculation circuit 106 also controls voltage setting for turning off the anode lines CL utilizing the light-on ratios at the timings when the lit EL elements 41 are turned off for every to-be-scanned cathode line RL, and the parameter data. At the timings when the lit EL elements 41 are turned off for every to-be-scanned cathode line RL using the light-off ratio at the timings when the lit EL elements 41 are turned off for every to-be-scanned cathode line RL, the drive voltage at which the anode lines CL are turned off is controlled to be variable, and an amount of voltage change observed in the lit elements when the display panel 40 is turned off is controlled. In this manner, any crosstalk occurring depending on the amount of voltage change observed in the lit elements when the display panel 40 is turned off can be reduced.

Modified Example

The invention is surely not restrictive to the first to fifth embodiments, and is applicable to various embodiments and possible for modification. Modified examples include the following A to C, for example.

A. In the embodiments, exemplified is the case of applying the invention to the drive apparatus of the passive drive display panel 40 using the EL elements 41. The invention is surely also applicable to light-emitting elements other than the EL elements 41, or to a drive apparatus of a display panel configured by a parallel plate using display elements, e.g., liquid crystal elements.

B. The cathode L line calculation circuit 74 in the third embodiment is configured to include the lookup table and the calculation circuit, and calculates a value of L with (L/the number of cathode lines n)×cathode drive voltage Vf. The parameters in the lookup table are light-on ratios of the EL elements 41 for every to-be-scanned cathode lines RL, and the calculation circuit calculates the light-on ratio through “0” data detection of the anode data output. Alternatively, the value of L may be calculated by the light-on ratio of the EL elements 41 for every to-be-scanned cathode line RL, and a specific equation.

C. Described in the fourth embodiment is the case of controlling the “L” (sync) drive performance of the anode driver 90, and described in the fifth embodiment is the case of controlling the turn-off drive voltage of the anode driver 110. The invention is surely applicable with any type of circuit, as long as the control means controls an amount of voltage change observed in the lit elements when the display panel 40 is turned off. Moreover, in both the fourth and fifth embodiments, detailed control may be applied to every to-be scanned cathode line RL.

### BRIEF DESCRIPTION OF THE DRAWINGS

FIG. 1 is a diagram showing the configuration of a drive apparatus of a passive drive display panel in a first embodiment of the invention;

FIG. 2 is a schematic circuit diagram showing an exemplary configuration in the drive apparatus of a passive drive display panel of a previous type;

FIGS. 3A to 3D are each a diagram showing the operation of cathode reset in the previous drive apparatus of FIG. 2;

FIG. 4 is a schematic timing diagram of the cathode reset of FIGS. 3A to 3D;

FIG. 5 is a schematic timing diagram for use to describe a problem of rapid increase observed in outputs of anode lines of FIG. 2;

FIG. 6A to 6D are each a diagram showing the cathode operation for anode voltage control with the cathode reset for the drive apparatus of FIG. 1;

FIG. 7 is a schematic timing diagram of the cathode reset of FIGS. 6A to 6D;

FIGS. 8A and 8B are each a schematic diagram showing a waveform of the anode operation with the cathode reset of FIG. 1, for comparison use with the previous example;

FIG. 9 is a schematic diagram showing the configuration of a drive apparatus of a passive drive display panel in a second embodiment of the invention;

FIG. 10 is a schematic timing diagram showing the control operation of the cathode reset when anode data of FIG. 9 indicates “0”;

FIG. 11 is a schematic diagram showing the configuration of a drive apparatus of a passive drive display panel in a third embodiment of the invention;

FIGS. 12A to 12C are each a diagram showing a waveform of the anode operation with the cathode reset of FIG. 11, for comparison use with FIG. 1;

FIG. 13 is a schematic diagram showing the configuration of a drive apparatus of a passive drive display panel in a fourth embodiment of the invention;

FIG. 14 is a diagram showing exemplary parameter data to be kept in a lookup table 104 of FIG. 13;

FIGS. 15A and 15B are each a diagram showing the operation of causing crosstalk when anodes of FIG. 13 are turned off;

FIGS. 15C and 15D are each a diagram also showing the operation of causing crosstalk when the anodes of FIG. 13 are turned off;

FIGS. 16A and 16B are each a schematic diagram showing the screen of a display panel 40 of FIG. 13;

FIG. 17 is a schematic timing diagram showing the mechanism of causing the crosstalk of FIG. 16;

FIG. 18 is a schematic diagram showing the configuration of a drive apparatus of a passive drive display panel in a fifth embodiment of the invention; and

FIG. 19 is a diagram showing exemplary parameter data to be kept in the lookup table 104 of FIG. 18.

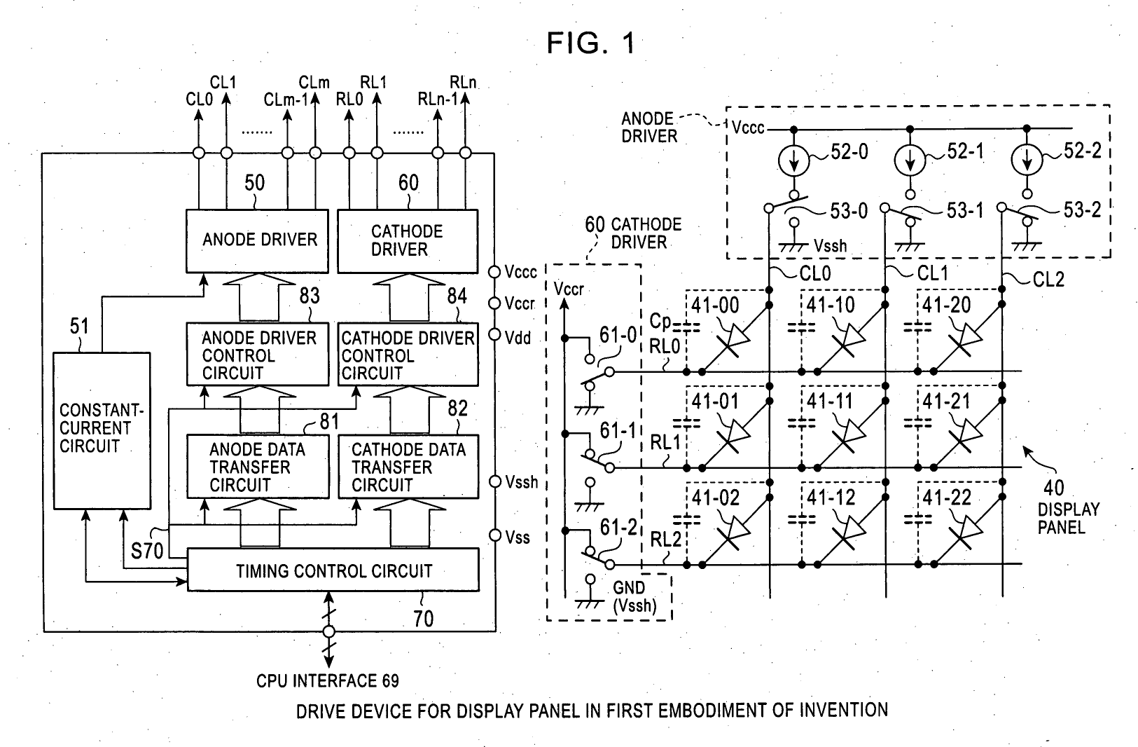

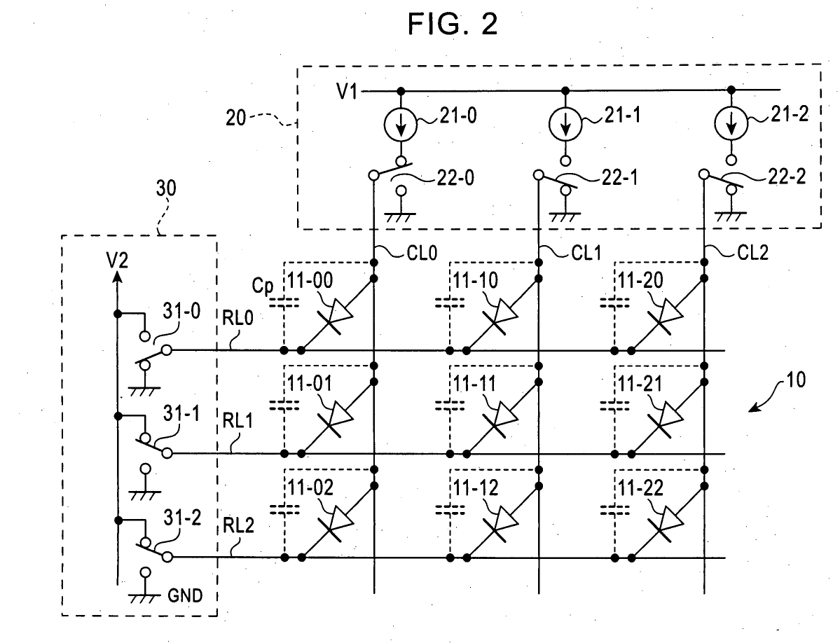

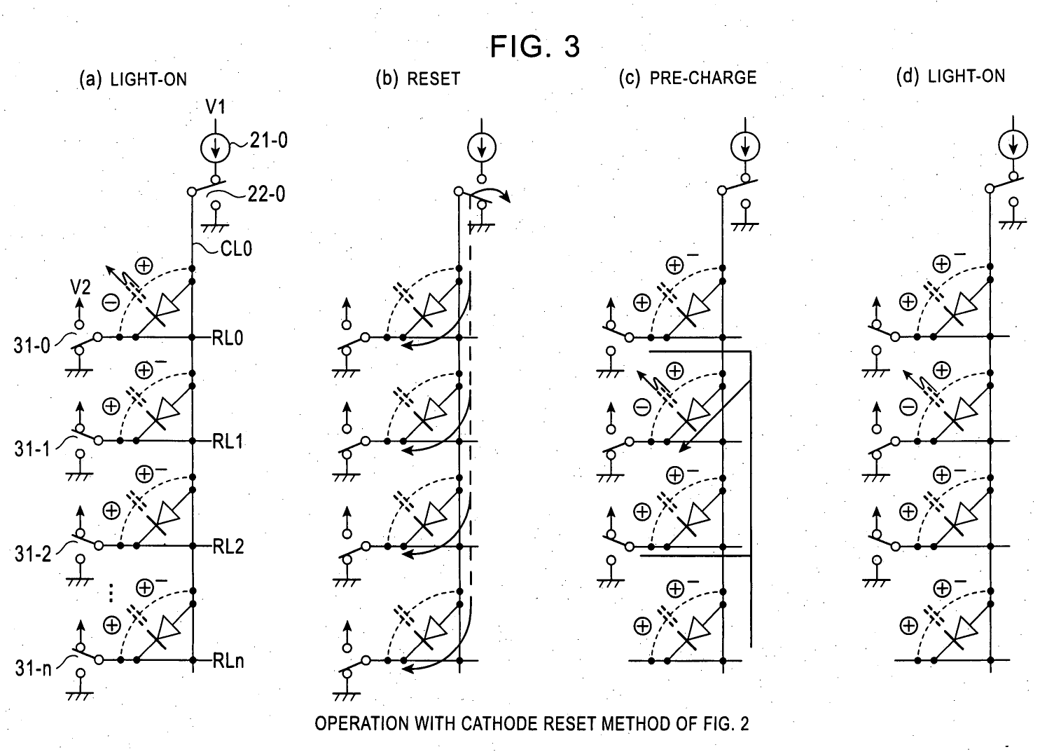

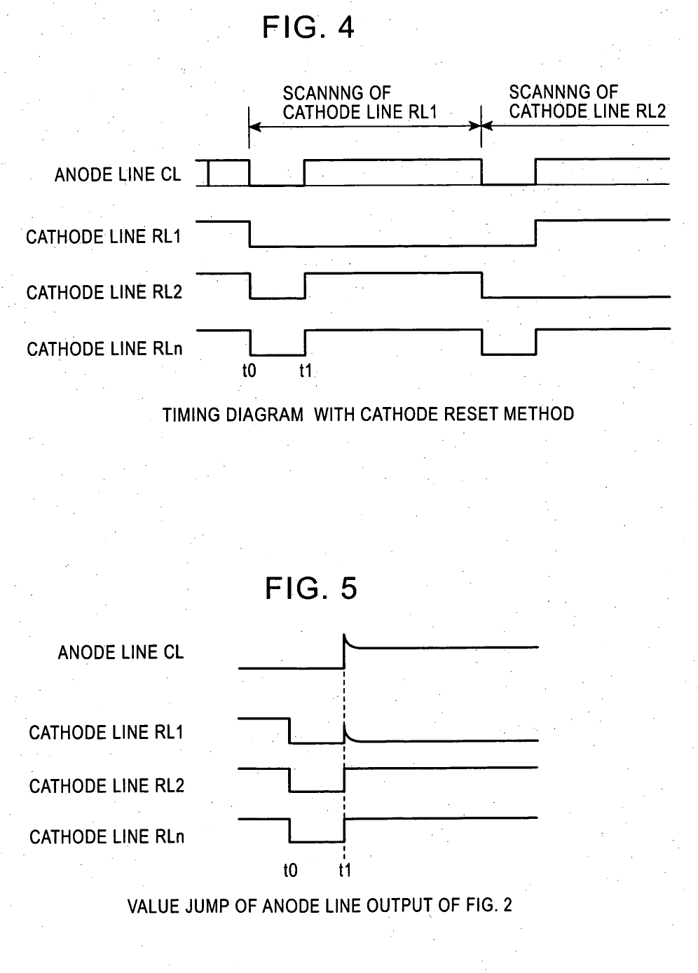

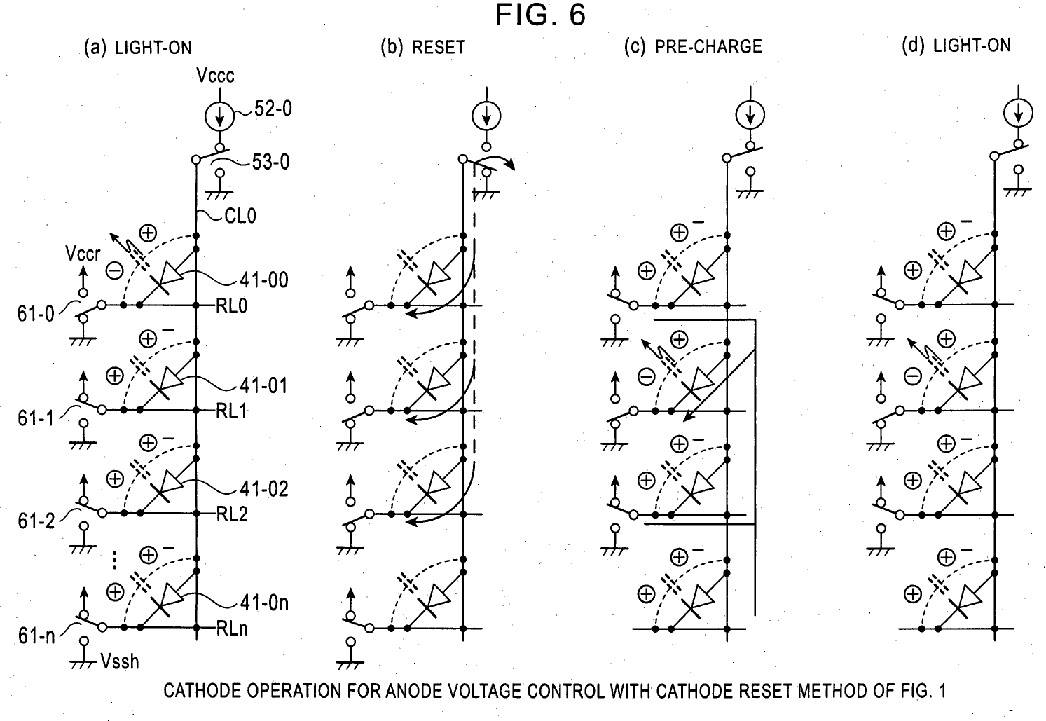

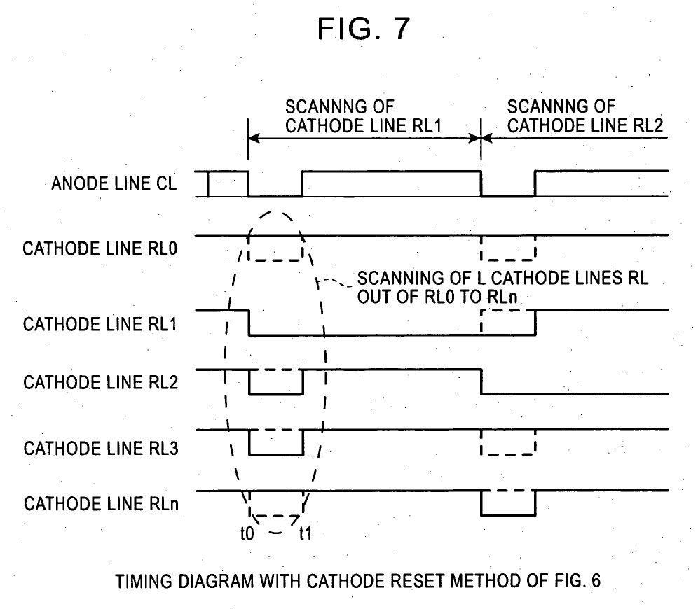

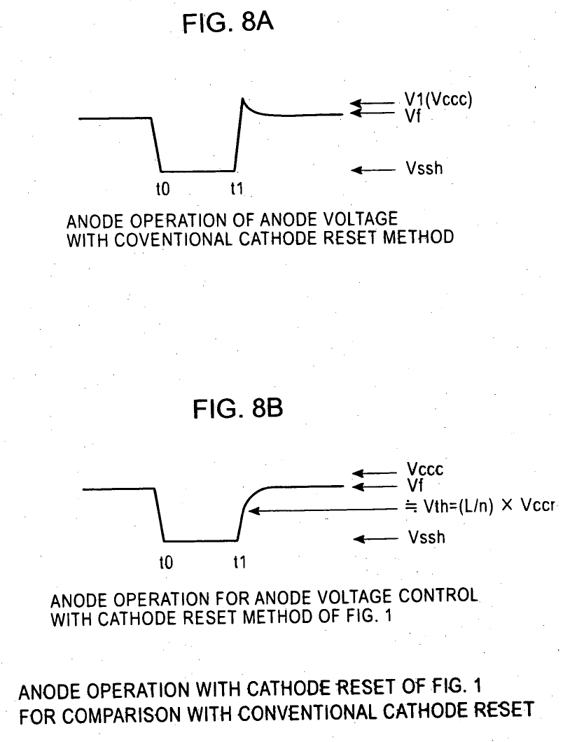

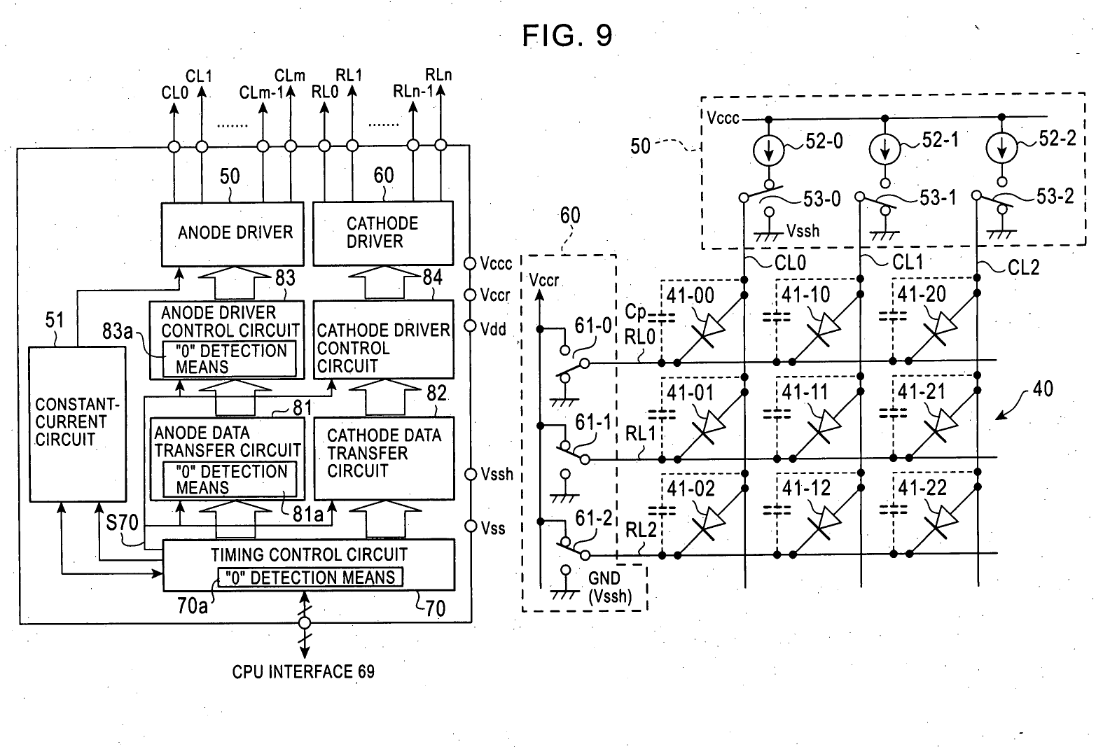

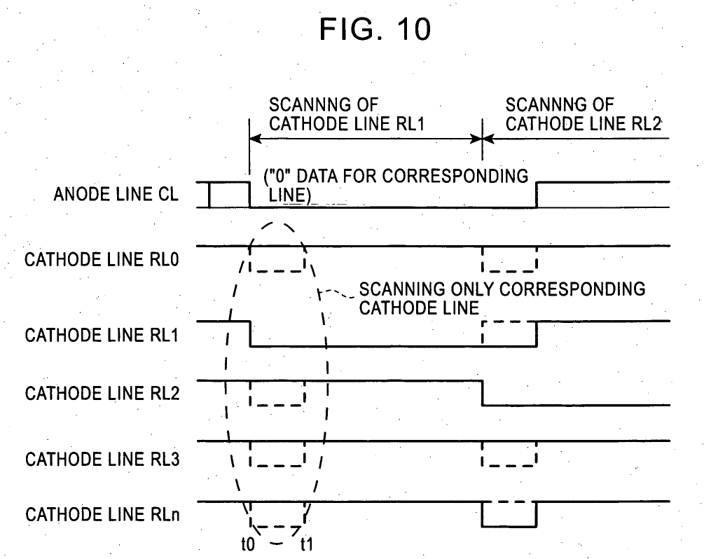

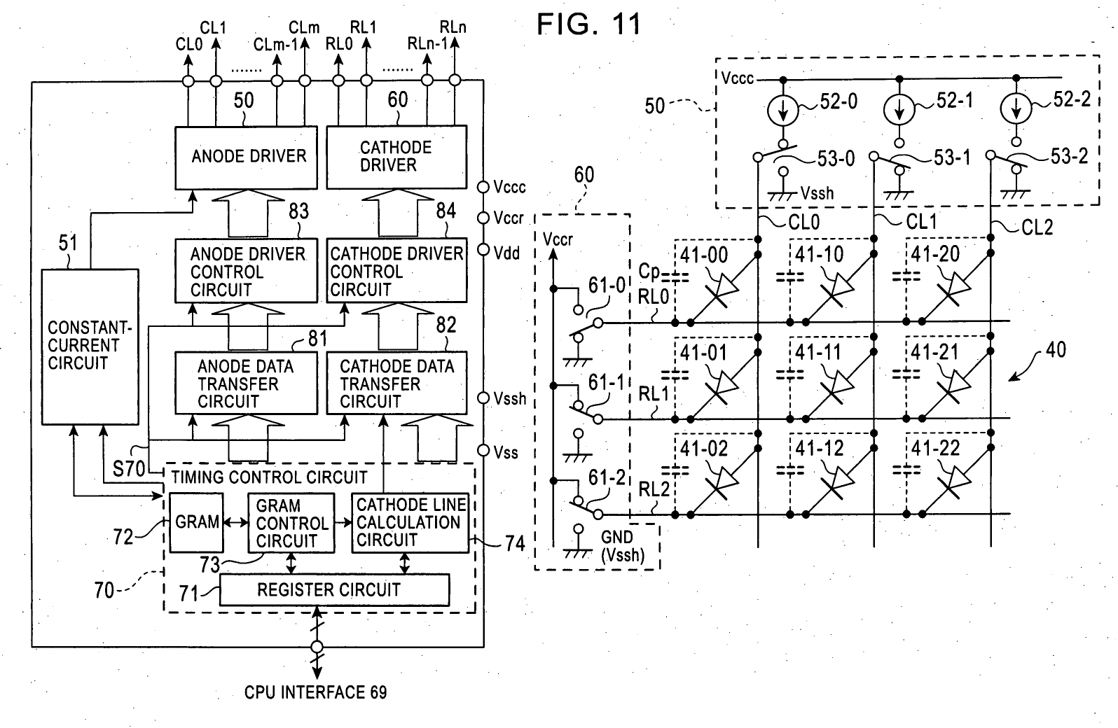

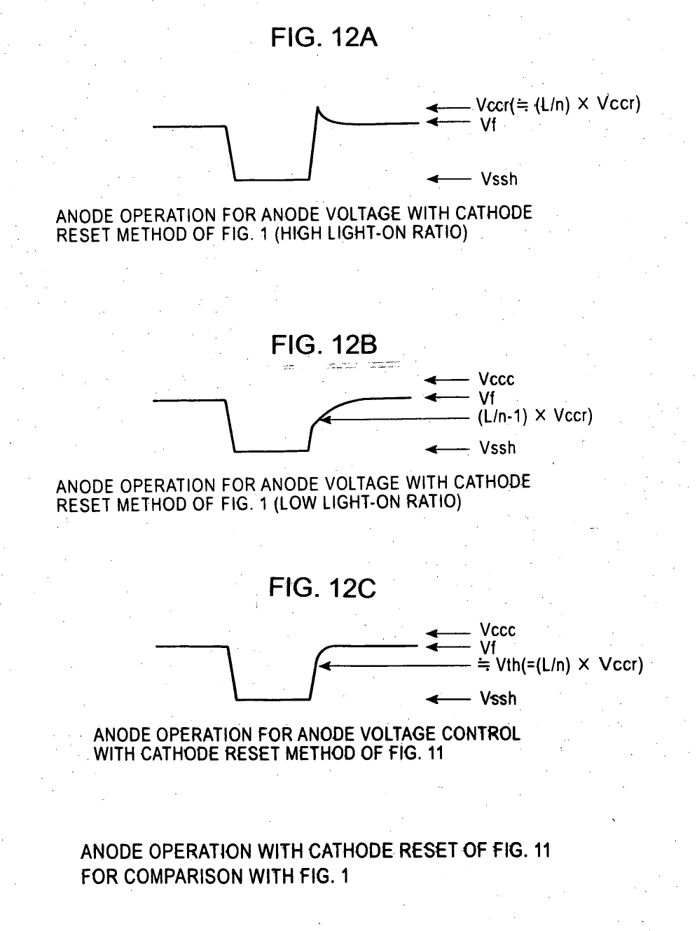

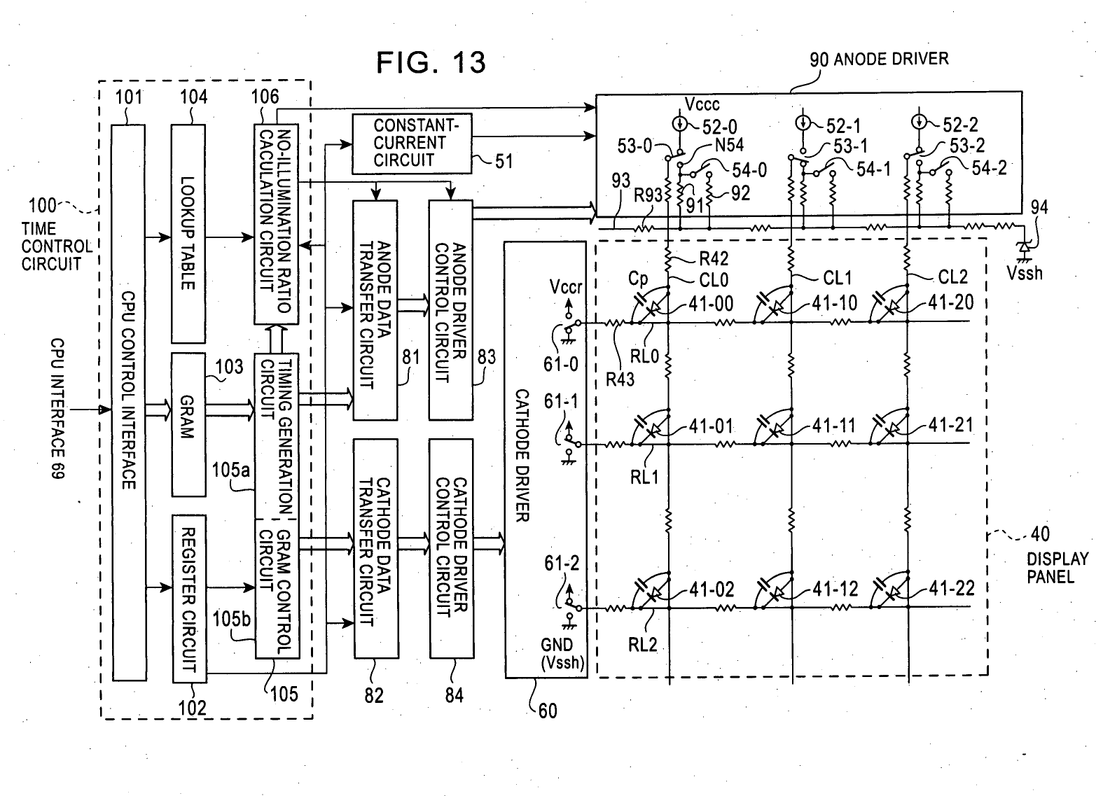

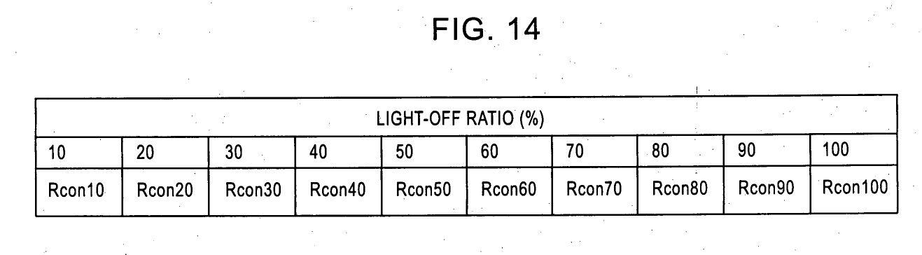

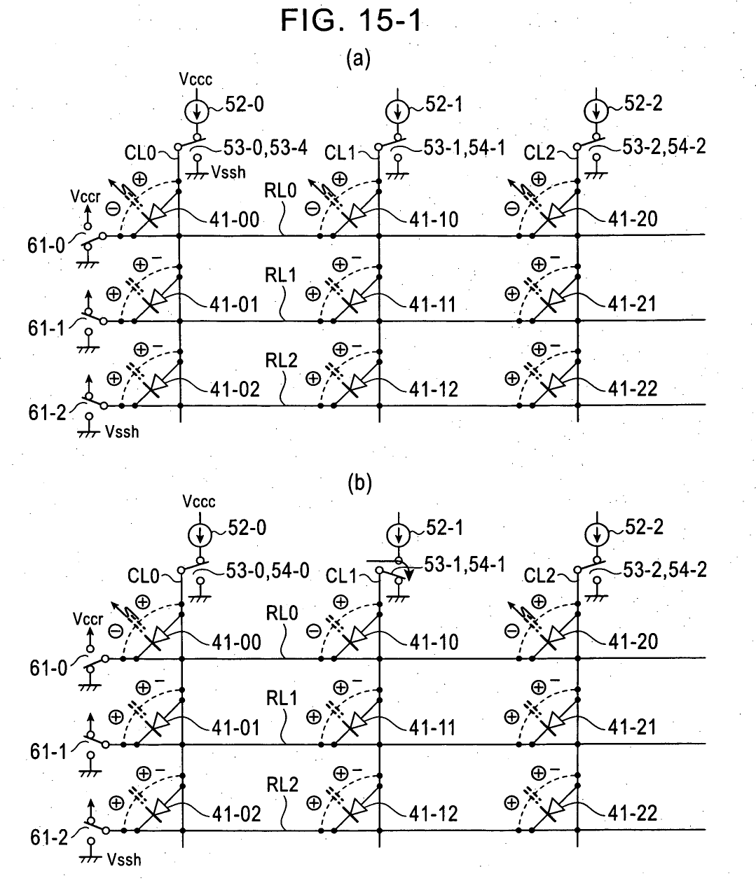

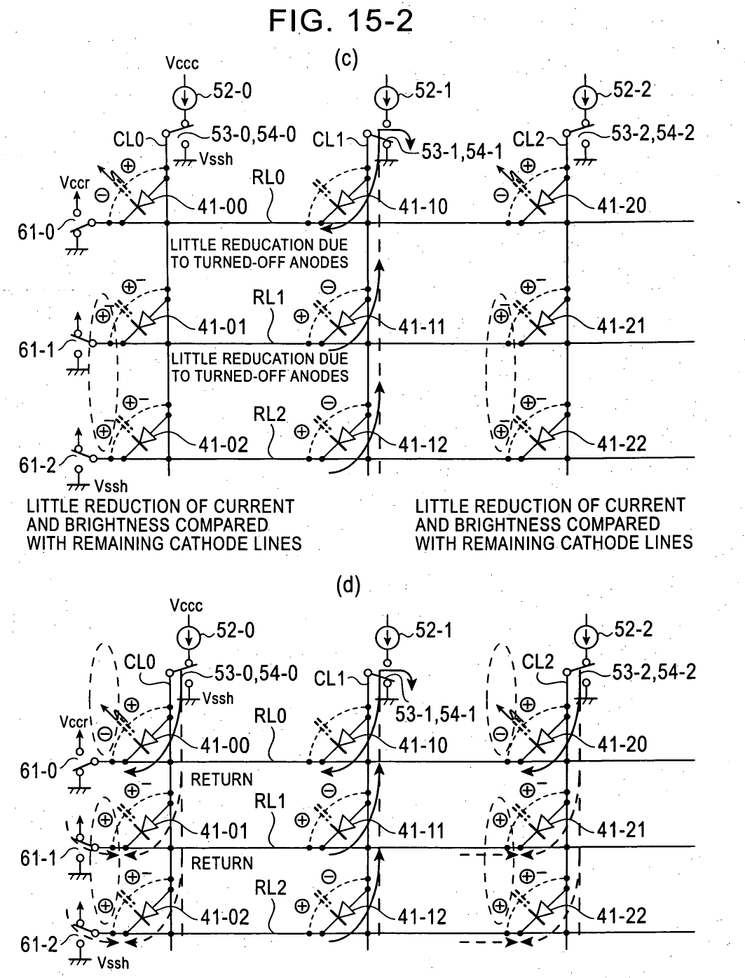

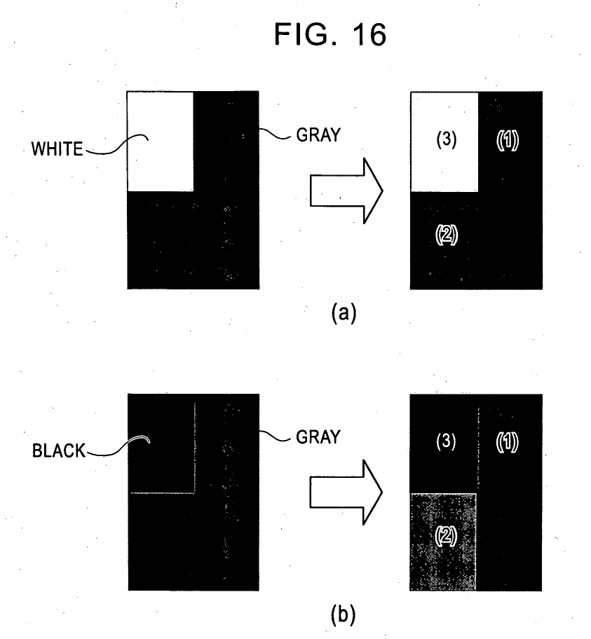

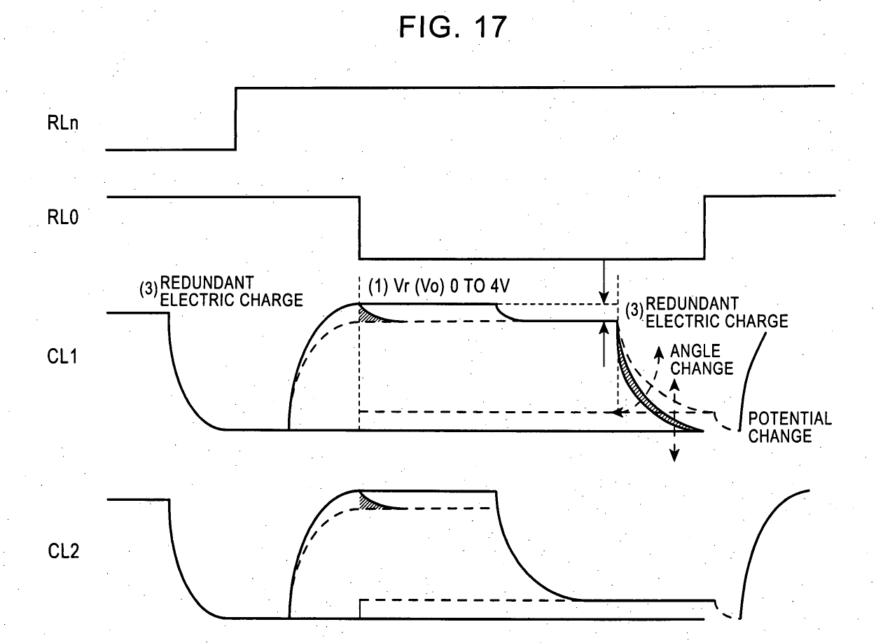

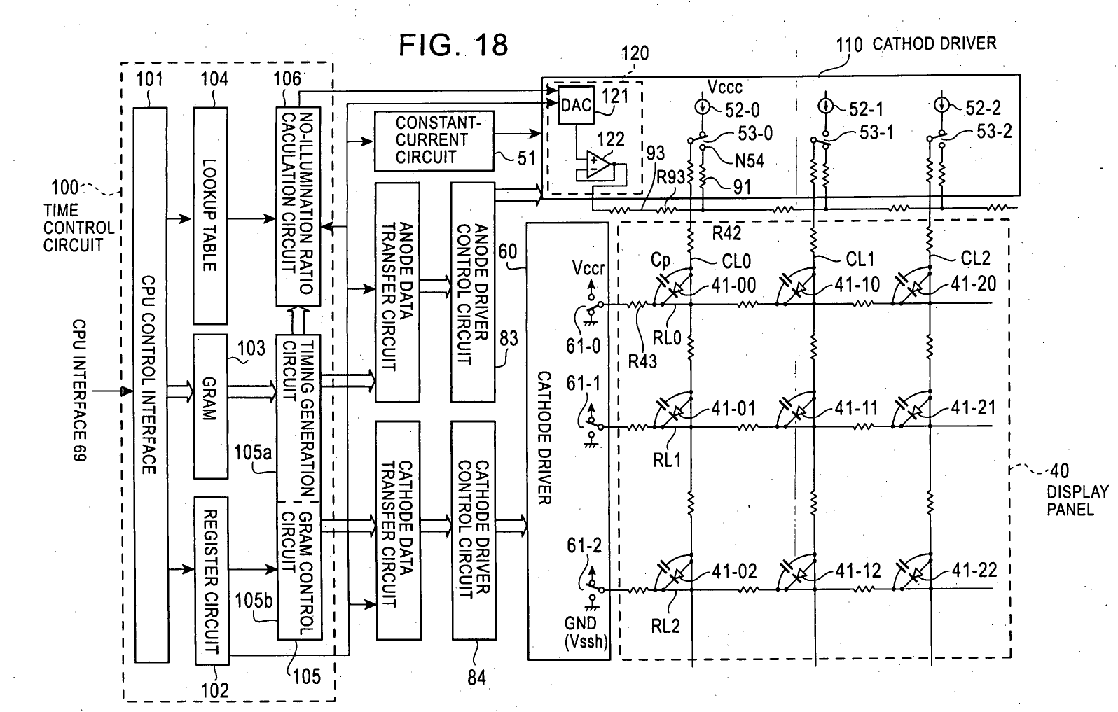

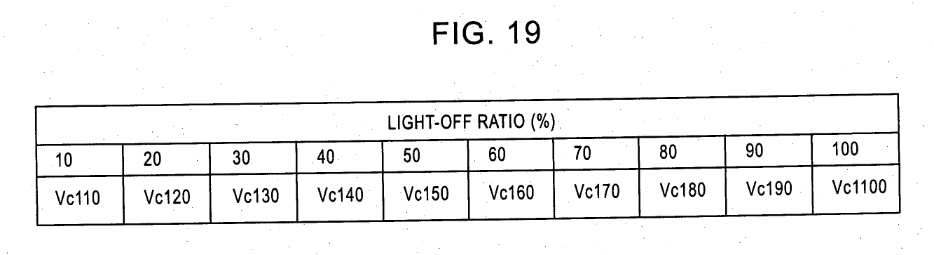

### EXPLANATION OF SIGNS

40 Display Panel
41 EL element
50, 90, 110 anode driver
51 constant current circuit
52, 52-0, 52-1, 52-2 constant current source
53, 53-0, 53-1, 53-2, 54, 54-0, 54-1, 54-2 drive switch
60 anode driver
61-0, 61-1, 61-2 scanning switch
70 timing control circuit
70a, 81a, 83a “0” detection means
81 anode data transfer circuit
82 anode data transfer circuit
83 anode driver control circuit
84 anode driver control circuit
91, 92 resistor
93 power supply line
104 look-up table
106 light-off ratio calculating circuit
120 “L” drive voltage setting circuit

What is claimed is:

1. A drive method, for a display panel in which a display element is connected to every intersection point of a plurality of data lines and a plurality of scan lines, of turning on the display elements with a flow of a drive current from the data lines to the scan lines via the display elements, the method comprising the steps of:
pre-charging a parasitic capacity of the display elements connected to any of the scan lines whichever selected, in which a parasitic capacity of the display elements connected to any of the scan lines not selected but predetermined is pre-charged; and
lighting the display elements connected to the selected scan line, in which the display elements connected to the selected scan line are driven to light.

2. A drive method, for a display panel in which a display element is connected to every intersection point of m (where m is a positive integer of 2 or larger) data lines and n (where n is a positive integer of 2 or larger) scan lines, of turning on the display elements by applying an output voltage of a data line drive circuit to the data lines, by switching a connection of the scan lines in a scan line drive circuit from a voltage terminal of receiving a drive voltage Vccr to a ground terminal of receiving a ground voltage, and by flowing a drive current from the data lines to the scan lines via the display elements, the method comprising the step of:
pre-charging a parasitic capacity of the display elements connected to any of the scan lines whichever selected, wherein
in the pre-charging step, a parasitic capacity of the display elements connected to L (where L is a positive integer) of the n scan lines is pre-charged by switching a connection of the L scan lines and the m data lines to the ground terminal, and by applying voltage control with (L/n)×Vccr for application of an initial output voltage of the data line drive circuit at about a display element drive voltage Vf.

3. A drive apparatus for a display panel in which a display element is connected to every intersection point of m (where m is a positive integer of 2 or larger) data lines and n (where n is a positive integer of 2 or larger) scan lines, the apparatus comprising:
a data line drive circuit that flows, when the display elements are lit, a drive current to the display elements through application of an output voltage to the data lines, and when the display elements are not lit, switches a connection of the data lines to a low-potential terminal;
a scan line drive circuit that switches a connection of, at the time of selection of the scan lines, the scan lines from a voltage terminal of receiving a drive voltage Vccr to a ground terminal of receiving a ground voltage, and not at the time of selection of the scan lines, switches a connection of the scan lines to the ground terminal; and
control means for pre-charging, in a process of pre-charging a parasitic capacity of the display elements connected to any of the scan lines whichever selected, a parasitic capacity of the display elements connected to L (where L is a positive integer) of the n scan lines by switching a connection of the L scan lines and the m data lines to the ground terminal, and by applying voltage control with (L/n)×Vccr for application of an initial output voltage of the data line drive circuit at about a display element drive voltage Vf.

4. A drive method, for a display panel in which a display element is connected to every intersection point of a plurality of data lines and a plurality of scan lines, of turning on the display elements by applying an output voltage of a data line drive circuit to the data lines, by changing a potential level of the scan lines from high to low in a scan line drive circuit, and by flowing a drive current from the data lines to the scan lines via the display elements, the method comprising the step of:
pre-charging a parasitic capacity of the display elements connected to any of the scan lines whichever selected, wherein
in the pre-charging step, when every data of the data lines is detected as being zero, only the selected scan line is changed in potential level to low when the data line drive circuit starts making an output, and a parasitic capacity of the display elements connected to the selected scan line is pre-charged.

5. A drive apparatus, for a display panel in which a display element is connected to every intersection point of a plurality of data lines and a plurality of scan lines, the apparatus comprising:
a data line drive circuit that flows, when the display elements are lit, a drive current to the display elements through application of an output voltage to the data lines, and when the display elements are not lit, switches a connection of the data lines to a low-potential terminal;
a scan line drive circuit that changes, at the time of selection of the scan lines, a potential level of the scan lines from high to low, and not at the time of selection of the scan lines, a potential level of the scan lines from low to high;
a detection circuit that detects, in a process of pre-charging a parasitic capacity of the display elements connected to the selected scan line, that every data of the data lines is being zero; and
control means for pre-charging, in the pre-charging process, based on a detection result derived by the detection circuit, when the data line drive circuit starts making an output, the parasitic capacity of the display elements connected to the selected scan line after changing the potential level to low only for the selected scan line.

6. A drive method, for a display panel in which a display element is connected to every intersection point of m (where m is a positive integer of 2 or larger) data lines and n (where n is a positive integer of 2 or larger) scan lines, of turning on the display elements by applying an output voltage of a data line drive circuit to the data lines, by switching a connection of the scan lines in a scan line drive circuit from a voltage terminal of receiving a drive voltage Vccr to a ground terminal of receiving a ground voltage, and by flowing a drive current from the data lines to the scan lines via the display elements, the method comprising the step of:
pre-charging a parasitic capacity of the display elements connected to any of the scan lines whichever selected, wherein
in the pre-charging step, a parasitic capacity of the display elements connected to L (where L is a positive integer) of the n scan lines is pre-charged by determining the value of L for the n scan lines using a light-on ratio of the display elements calculated for each of the scan lines, by switching a connection of the L scan lines and the m data lines to the ground terminal, and by controlling an initial output voltage of the data line drive circuit with (L/n)×Vccr.

7. A drive apparatus for a display panel in which a display element is connected to every intersection point of m (where m is a positive integer of 2 or larger) data lines and n (where n is a positive integer of 2 or larger) scan lines, the apparatus comprising:
a data line drive circuit that flows, when the display elements are lit, a drive current to the display elements through application of an output voltage to the data lines, and when the display elements are not lit, switches a connection of the data lines to a low-potential terminal;
a scan line drive circuit that switches a connection of, at the time of selection of the scan lines, the scan lines from a voltage terminal of receiving a drive voltage Vccr to a ground terminal of receiving a ground voltage, and not at the time of selection of the scan lines, switches a connection of the scan lines to the ground terminal;
a calculation circuit that determines, in a process of pre-charging a parasitic capacity of the display elements connected to any of the scan lines whichever selected, a value of L (where L is a positive integer) for the n scan lines based on a light-on ratio of the display elements calculated for each of the scan lines; and
control means for pre-charging, in the pre-charging process, a parasitic capacity of the display elements connected to the L scan lines by switching a connection of the L scan lines determined by the calculation circuit and the m data lines to the ground terminal, and by controlling an initial output voltage of the data line drive circuit with (L/n)×Vccr.

8. A drive method for a display panel in which a display element is connected to every intersection point of a plurality of data lines and a plurality of scan lines, comprising the steps of:
turning on the display elements connected to any of the scan lines whichever selected and the data lines; and
turning off the lit display elements, wherein
when turning the display elements on, the selected scan line is switched in connection from a voltage terminal of receiving a drive voltage to a ground terminal of receiving a ground voltage, and a drive current is supplied to the data lines to light the display elements, and
when turning off the display elements turned on, the selected scan line is switched in connection from the ground terminal to the voltage terminal to put the scan line in a no-selected state, and a potential level of the data lines is changed to low to turn off the display elements, and
when the display elements are turned off, a light-off ratio is calculated for the display elements connected to the selected scan line to see how much of the lit display elements are turned off, and based on the light-off ratio, a voltage of the low-potential level is changed to control an amount of voltage change observed in the lit display elements when the display panel is turned off.

9. A drive apparatus for a display panel in which a display element is connected to every intersection point of a plurality of data lines and a plurality of scan lines, the apparatus comprising:
a data line drive circuit that flows, when the display elements are lit, a drive current to the display elements through a supply thereof to the data lines, and when the display elements are not lit, switches a connection of the data lines to a low-potential level;
a scan line drive circuit that switches a connection of, at the time of selection of the scan lines, the scan lines from a voltage terminal of receiving a drive voltage to a ground terminal of receiving a ground voltage, and not at the time of selection of the scan lines, switches a connection of the scan lines to the ground terminal;
a calculation circuit that calculates a light-off ratio for the display elements connected to the scan lines to see how much of the lit display elements are turned off; and
control means for controlling, based on the light-off ratio calculated by the calculation circuit, a voltage of the low-potential level is changed to control an amount of voltage change observed in the lit display elements when the display panel is turned off.

10. The display panel drive apparatus according to claim 9, wherein
based on the light-off ratio, the voltage of the low-potential level is changed by varying an on-resistance of a drive switch.

11. The display panel drive apparatus according to claim 9, wherein
based on the light-off ratio, the voltage of the low-potential level is changed by a drive voltage setting circuit.

12. The display panel drive method according to claim 1, wherein
the display element is a light-emitting element including an organic electroluminescence element.

13. The display panel drive method according to claim 2, wherein
the display element is a light-emitting element including an organic electroluminescence element.

14. The display panel drive method according to claim 4, wherein
the display element is a light-emitting element including an organic electroluminescence element.

15. The display panel drive method according to claim 6, wherein
the display element is a light-emitting element including an organic electroluminescence element.

16. The display panel drive method according to claim 8, wherein
the display element is a light-emitting element including an organic electroluminescence element.

17. The display panel drive method according to claim 3, wherein
the display element is a light-emitting element including an organic electroluminescence element.

18. The display panel drive method according to claim 5, wherein
the display element is a light-emitting element including an organic electroluminescence element.

19. The display panel drive method according to claim 7, wherein
the display element is a light-emitting element including an organic electroluminescence element.

20. The display panel drive method according to claim 9, wherein
the display element is a light-emitting element including an organic electroluminescence element.
